(19) United States
(12) Patent Application Publication
(10) Pub. No.: US 2025/0381491 A1
(43) Pub. Date: Dec. 18, 2025

(54) INTERACTIVE ANIMATRONIC SYSTEMS USING DYNAMIC AI-DRIVEN MOTOR RESPONSES

(71) Applicant: Hasbro, Inc., Pawtucket, RI (US)

(72) Inventors: Gray Bright, Cranston, RI (US); Scott S. Clark, Barrington, RI (US)

(21) Appl. No.: 19/236,879

(22) Filed: Jun. 12, 2025

Related U.S. Application Data
(60) Provisional application No. 63/660,357, filed on Jun. 14, 2024.

(51) Int. Cl. A63H 3/36; G06F 40/279; G06F 40/40; G06V 20/50; G10L 13/033

(52) U.S. Cl. CPC A63H 3/36; G06F 40/279; G06F 40/40; G06V 20/50; G10L 13/033

(57) ABSTRACT

Disclosed herein are systems and methods for synchronizing bucketized animations with AI-driven responses in interactive toys and animatronic objects. The systems include toys equipped with multiple motors enabled to control movement of different segments, where each motor is associated with a corresponding movement path. Input content is received and used to construct prompts that operate as an input in an AI model to generate narrative responses along with metadata defining sequences of movements. The metadata is mapped to bucketized animations that are executed using the motors for specific time periods. The systems and methods enable concurrent/synchronized presentation of AI-generated narratives through speakers and the bucketized animations.

### CROSS-REFERENCE TO RELATED APPLICATION(S)

This application claims priority to, and the benefit of, U.S. Provisional Patent Application Ser. No. 63/660,357 filed on Jun. 14, 2024, incorporated herein by reference in its entirety.

### BACKGROUND

Artificial intelligence (“AI”) models often operate based on extensive and enormous training models. The models include a multiplicity of inputs and how each should be handled. Then, when the model receives a new input, the model produces an output based on patterns determined from the data the model was trained on.

Large language models (“LLMs”) are trained using large datasets to enable them to perform natural language processing (“NLP”) tasks such as recognizing, translating, predicting, or generating text or other content. One example of an existing LLM is ChatGPT. A recent trend in AI is to make use of general-purpose generative AI applications built on LLMs. An example of such an application is the ChatGPT family of OpenAI models. The general-purpose generative AI applications make use of a natural language chat interface for humans to make requests to the LLM. At the time of filing, general-purpose generative AI's initial attempt at responding to a user's queries is middling and requires query refinement from the user. Over the course of a given chat session, the user refines their queries (e.g., by rephrasing or specifying details), and the general-purpose model provides a more accurate and relevant response.

### BRIEF DESCRIPTION OF THE DRAWINGS

FIG. 1 is a diagrammatic view illustrating generally a validation process in accordance with the invention.

FIG. 2 is a flowchart illustrating a method of performing the validation process in FIG. 1.

FIG. 3A is a diagram illustrating one embodiment of the architecture of the validation framework as applied to validating language model outputs in a trivia game.

FIG. 3B is a diagram illustrating one embodiment of the architecture of the validation framework as applied to validating user inputs in a trivia game.

FIG. 4 is a screenshot of one embodiment of a front-end interface as applied to a trivia game.

FIG. 5 is a flowchart illustrating an example method of implementing a synthetic user using the validation process in FIG. 1.

FIG. 6 is a screenshot of one embodiment of a front-end interface as applied to an Ouija board game.

FIG. 7 is a flowchart illustrating an example method of implementing the synthetic user through an interactive toy.

FIG. 8 is a flowchart illustrating an example method of synchronizing bucketized (e.g., clustered, categorized, grouped, physical) animations with the synthetic user's responses of an interactive toy.

FIG. 9 is a diagram illustrating an example interactive playset environment using AI-driven narrative generation.

FIG. 10A is a diagram illustrating an example interactive toy using AI-driven narrative generation.

FIG. 10B is a diagram illustrating the presentation of the generated narrative by projecting a display using the interactive toy of FIG. 10A.

FIG. 11 is a block diagram illustrating an example computer system, in accordance with one or more embodiments.

FIG. 12 is a high-level block diagram illustrating an example AI system, in accordance with one or more embodiments.

### DETAILED DESCRIPTION

Tabletop games and playset environments have been popular forms of entertainment, each offering distinct experiences. The integration of generative AI technology in tabletop games enables a unique and dynamic gameplay experience. For example, AI technology can be harnessed to produce an extensive range of questions, prompts, and Ouija board responses based on diverse input data. An AI engine formulates trivia questions based on input parameters, such as category, difficulty level, and desired question format (multiple choice, true/false, open-ended, etc.). The output questions are expected to challenge participants while ensuring clarity and coherence. Similarly, an AI engine generates responses for the Ouija board sessions, designed to facilitate play. The responses are influenced by the context of the game and are customizable to align with different paranormal themes.

However, there is the potential for erroneous, misleading, or otherwise undesirable, responses from the generative AI engine. The errors arise from various sources, such as inaccuracies in the training data, limitations in the model architecture, and/or the probabilistic nature of AI predictions. For example, the generative AI engine may lack the ability to verify the veracity of statements made by users. Without verification, the generative AI engine may generate responses based on false information provided by users. Another example occurs when the training data used to develop the generative AI engine contains biases or skewed representations. In that case, the generated content may inadvertently reflect those biases, potentially leading to inappropriate or inaccurate responses. Additionally, if the generative AI engine encounters a situation where the generative AI engine lacks adequate information to generate a response, the generative AI engine will attempt to infer or guess, potentially leading to inaccurate content.

Another concern is when users provide input that is unconventional, vague, or entirely unrelated to the intended context, which challenges the generative AI engine's ability to generate appropriate responses. Input as described can be due to an attempt to jailbreak the generative AI engine, a form of hacking that aims to bypass an AI model's ethical safeguards and elicit prohibited information.

Even in potentially favorable circumstances, a generative AI typically provides what a user asks for in a literal sense and does not accommodate for what the user really wants to know. Humans will provide imprecise input that receives similarly imprecise output. For example, a human will request trivia questions on a certain topic, and the generative AI will take the path of least computation and provide a set of nearly identical, but technically different questions. The human did not specify that the questions needed to be varied, and the model accordingly did not vary them. Further, a user can only do so much with a given query. Queries to generative models typically have character maximums, or query buffers of a limited size in order to control execution speed. In such circumstances, a user's input may only be as specific as the query buffer allows.

In addition to being procedurally inefficient, using generative AI models for gameplay also results in another technical problem: the black-box nature of many AI models, where the internal workings of the model are not transparent. The opacity makes it difficult to understand and mitigate errors of the response. For example, a black-box model may make a decision based on spurious correlations in the data, but without insight into the model's reasoning process, it is challenging to identify and correct these errors.

The technical problem is further compounded due to AI models operating on a next-best-token framework. The next-best-token framework predicts the next word or token in a sequence by considering the preceding words or tokens. For example, the AI model calculates the probability distribution over the possible next tokens and selects the one with the highest probability as the next output. The next-best-token framework may lead to outputs that deviate from the intended path because the model's decisions are based on local probabilities rather than a global understanding of the overall context or the user's ultimate goal. For example, if an AI model is asked to generate a story and the AI model encounters a vague prompt, the model may start generating content that diverges significantly from the user's intended narrative. The AI model may continue with a common or statistically likely sequence, but the sequence may not align with the specific direction or theme the user had in mind. Therefore, the next-best-token framework may struggle with maintaining long-term coherence and consistency in the generated text, as the framework focuses on immediate token predictions rather than the overall narrative structure.

Human intervention to correct the errors in the undesirable responses of the AI model is impractical, especially in real-time applications where quick/immediate responses are desired. For example, in live gameplay, the immediacy and flow of interaction substantially affect the user experience. In trivia games, players expect rapid-fire questions and answers to maintain the pace and excitement of the game. If an AI model generates an incorrect or misleading question, waiting for a human to review and correct the question disrupts the flow of the game, causing frustration among players. Further, in a question-response setting (e.g., chat-based interactions, chatbots), users interact with the AI in a continuous and fluid manner, oftentimes seeking real-time or near-real-time responses to their queries. If the AI produces an inappropriate or nonsensical response, pausing the interaction for human correction would break the immersive experience and reduce the effectiveness of the application. Moreover, the volume of interactions in these gameplay scenarios is substantial due to multiple users engaging with the AI simultaneously.

To address the technical problems in AI-generated content, the validation framework seeks to ensure the accuracy, relevance, and reliability of AI-generated content in any game system, such as a trivia or Ouija board game system. To achieve these goals in a practical, automatic, and substantially real-time manner, the validation framework employs AI (or other heuristic check) watching AI. By upholding these criteria, the validation mechanism increases user trust, improves the gameplay experience, and improves to the game system's overall reliability and effectiveness.

The validation process is orchestrated by an amalgamation of distinct AI models, each tailored to address specific facets of content assessment. The AI models are integrated within an architectural superstructure that allows for synchronized execution. The architectural superstructure acts as a computational backbone, facilitating the parallel execution of independent validation models. The independent validation models use pre-loaded query context to validate specific checks pertaining to the use of a main model (e.g., a generative AI model, GenAI, GAI). The pre-loaded query context functions as parameters that guide the distinct AI models in discerning compliance with predetermined model-driven conditions that limit undesirable input and output to/from the main model. The pre-loaded query context serves as a contextual framework, enabling the system to dynamically adapt system validation criteria based on the unique characteristics of both the main model and the user input.

The validation framework enables various additional technical advantages. For example, the validation framework addresses the potential for erroneous, misleading, or otherwise undesirable responses from the generative AI engine by implementing multiple layers of validation on both the user input and the model output. For example, accuracy checks cross-reference the AI's responses with external knowledge databases and sources to ensure the accuracy of the information provided. Bias checks identify and mitigate biases present in the training data, reducing the likelihood of generating biased or skewed content. When the AI engine encounters situations where the AI engine lacks adequate information, the validation framework flags the instances and requests additional input from the user and/or provides a disclaimer about the potential uncertainty of the response.

Further, the validation framework mitigates limitations of the next-best-token framework by using a global context to validate the response of the AI engine. By weaving together multiple validating models that operate in parallel, the validation framework ensures that each token prediction is checked against a broader context (e.g., the entire response, geographical location, time period, and so forth) defined by the multiple validating models. The validation framework validates the consistency of the AI's responses over extended interactions. The parallel validation is particularly advantageous for live gameplay, since the parallel structure enables the system to process multiple aspects of validation concurrently and thus reducing latency that would occur from validating the content against each aspect one at a time. Each model operates independently but is managed by a consensus module that determines the overall validity of the content by aggregating the results from the various validation models. Using the validation framework, a larger amount of content (e.g., trivia questions) can be generated over a shorter period of time.

Additionally, traditional playsets typically involve physical figurines and settings, allowing users to create their own stories and scenarios through imaginative play. These playsets include character figurines, buildings, and various object figurines to build scenes and narratives. However, traditional playsets are limited by their static nature and rely solely on the user to construct the narratives. The storytelling possibilities are confined to the user's imagination and the predefined attributes of the characters and objects. This often leads to repetitive play and limited narrative development. Children may quickly exhaust the potential scenarios, reducing the longevity of the playset.

Furthermore, even in playsets that have pre-recorded narratives, there is no variability and/or unpredictability within the narratives. Conventional systems typically rely on pre-programmed responses or static decision trees that cannot adapt to the variability of physical arrangements and environmental changes (e.g., changes due to user interaction) that occur during interactive play. The stories generated in traditional playsets follow predefined and predictable patterns, which can decrease excitement and engagement over time. The lack of interactivity can result in a less engaging experience, as users are unable to influence the story dynamically.

To address the limitations of traditional playsets, the proposed system includes a interactive storytelling platform (e.g., a toy, a playset environment) that addresses these limitations by integrating physical playset environments with AI-driven narrative generation. The platform includes a stage enabled to identify one or more characters and/or objects simultaneously. Each character or object is tagged with a unique identifier that is recognized through cloud connectivity, a Near Field Communication (“NFC”) tag, manual input, and/or identified through audio, image, and/or video input by the user. An AI model receives or otherwise obtains user inputs (e.g., placing characters or objects on the stage, button-pressing on the stage, audio input) and generates dynamic, personalized storylines that integrate the characters and/or objects placed on the stage.

By combining physical play with AI-driven narratives, playsets become dynamic, interactive environments that improve creativity and engagement. The interactive storytelling platform maintains user engagement through unpredictable and contextually relevant story development by using multiple simultaneous inputs-such as spatial positioning, object recognition, and user interactions—to generate a responsive entertainment environment that adapts to changing conditions rather than relying on pre-programmed content libraries.

While the present technology is described in detail for use with trivia (such as Trivial Pursuit), Ouija board game systems, and/or physical play environments, the technology could be applied, with appropriate modifications, to improve the playability of other applications, making the technology a valuable tool for diverse applications beyond tabletop games and playset environments. The examples provided in this paragraph are intended as illustrative and are not limiting. Any other game referenced in this document, and many others unmentioned are equally appropriate after appropriate modifications.

The invention is implemented in numerous ways, including as a process; an apparatus; a system; a composition of matter; a computer program product embodied on a computer-readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description that references the accompanying figures follows. The scope of the invention is limited only by the claims and the invention encompasses numerous alternatives, modifications, and equivalents. Numerous specific details are set forth in the following description in order to provide a thorough understanding of the disclosure. These details are provided for the purpose of example and the invention may be practiced according to the claims without some or all of these specific details. For the purpose of clarity, technical material that is known in the technical fields related to the invention has not been described in detail so that the invention is not unnecessarily obscured.

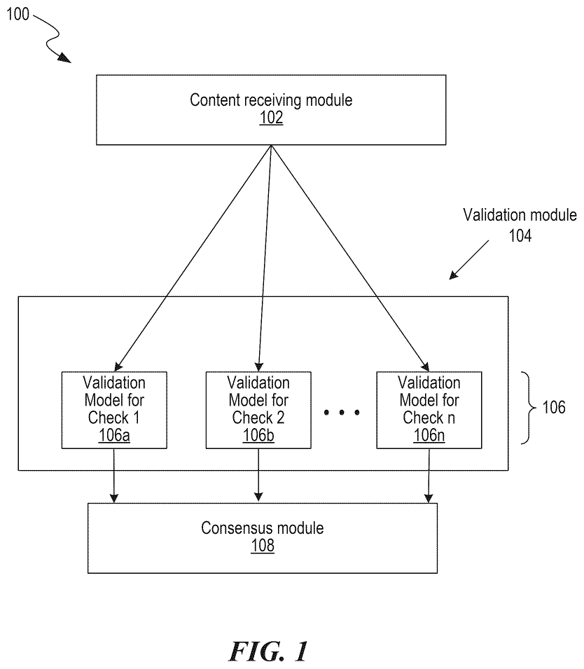

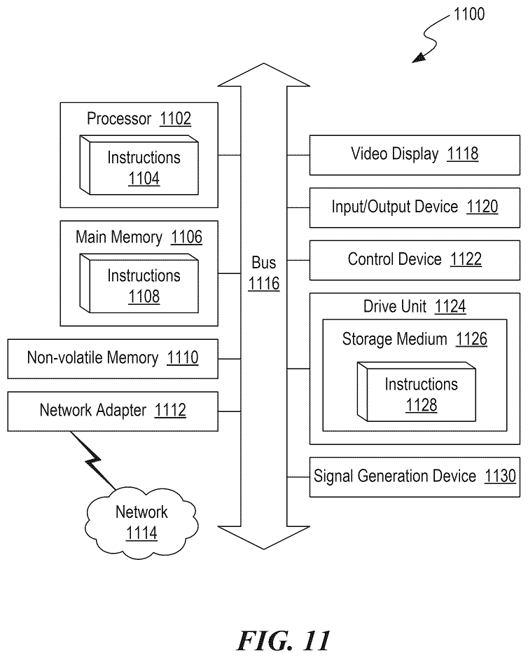

FIG. 1 is a diagrammatic view illustrating generally a validation framework 100. The validation framework 100 includes a content receiving module 102, a validation module 104, validation models 106 (e.g., a first validation model 106a, a second validation model 106b, and so forth), and a consensus module 108. The validation framework 100 is implemented using components of example computer system 1100 illustrated and described in more detail with reference to FIG. 11. Implementations of the validation framework 100 can include different and/or additional components or can be connected in different ways.

The validation framework 100, in some embodiments, has a content receiving module 102 that receives inputs from a user or outputs from a model. In some embodiments, the content receiving module 102 receives an output of a generative AI engine comprising of neural network-based architecture, such as an LLM. The output of the model, in some embodiments, is in a string format. However, in scenarios where JavaScript Object Notation (“JSON”) formatting is required, the configuration is specified within the pre-loaded query context. As is described in greater detail below, in the context of a trivia game, the content receiving module 102 receives a topic request from a user in some embodiments. In some embodiments, in the context of a trivia game, the content receiving module 102 receives the output from a generative AI engine, wherein the output is in the form of at least a trivia response (both correct and incorrect). A trivia response specifically pertains to the entirety of one or more trivia questions and the corresponding set of multiple-choice answers and/or schedule of accepted answers (in view of short answer or fill-in-blank type trivia).

In some embodiments, when interacting with an interactive toy, the content receiving module 102 receives narrative content or character dialogue generated by an AI model for presentation through the toy. The interactive toy includes, for example, physical toy(s) equipped with speakers, displays, and/or motorized components that are enabled to present AI-generated narratives, character voices, and/or animated movements. The content receiving module 102 is enabled to receive input data from physical toy interactions, such as user commands spoken to the toy, physical manipulation of toy components, and/or placement of toy figurines on interactive surfaces (e.g., a surface of a physical toy playset). The AI-generated output includes, for example, character dialogue emulating specific personality traits, narrative segments that respond to user actions, instructions for coordinating physical movements or visual representations (e.g., light) with spoken content, and so forth.

The data received by the content receiving module 102 is transmitted/received into a validation module 104. In some embodiments, the validation module includes a validation model 106. In some other embodiments, the validation module includes a plurality of validation models, 106a, 106b, and so on through 106n, for a total of n models, where n equals the number of validation models. The data received by the content receiving module 102 is validated through the validation model(s) 106a through 106n. In some embodiments, the data is validated by the validation model(s) 106a through 106n in tandem using a parallel data processing mechanism. In some embodiments, the parallel data processing mechanism includes running a plurality of central processing units (“CPUs”) concurrently on a single system, where the system distributes the computational load across multiple processors. For example, when a child places multiple character figurines on an interactive playset and requests a story, the validation models simultaneously evaluate the request and/or the generated narrative across multiple dimensions (i.e., across the validation model(s) 106a through 106n).

Each of the validation model(s) 106a through 106n reviews some predefined aspect of the input to the content receiving module 102. A distinctive element of each of the validation model(s) 106a through 106n is pre-loaded query context that is employed along with the input to the content receiving module 102. In some embodiments, the validation model(s) 106a through 106n employ varied model architecture and training sets. In some embodiments, the same model architecture and training set is employed for the validation model(s) 106a through 106n.

In some embodiments, one of the validation models 106a through 106n includes a topic check. The topic check is pre-loaded with a query context that encompasses a list of prohibited topics, encapsulated in a structured data format such as JSON. The topic check identifies and/or denies content (e.g., queries from the user, responses from the AI engine). In some embodiments, support vector machines (“SVM”) are used to classify whether the content belongs to a certain category (e.g., permissible or impermissible content). For example, the validation model 106a through 106n of the topic check is trained on a dataset that includes examples of permissible and impermissible content to enable the validation model 106a through 106n to learn the distinguishing features of each category. In some embodiments, the topic check extracts semantic (e.g., using word embeddings), syntactic (e.g., using part-of-speech taggings or dependency parsing), and contextual features (e.g., using attention mechanisms in transformer models) from textual data to enable the model (e.g., the SVM) to distinguish between permissible and impermissible content.

For example, a trivia game under a particular configuration is not interested in including questions about serial killers. The topic block is approachable either explicitly (e.g., the user asked for questions about serial killers) or implicitly (e.g., the user asked for questions about a specific person who fits the definition of serial killer). However, a given topic requested may be “The Silence of the Lambs,” a film that concerns a fictional serial killer, Hannibal Lecter. In such a circumstance, in some embodiments, a fictional or entertainment-related bypass is enabled by framing the topic check as to whether the trivia question is more related to the prohibited topic (e.g., serial killers) or more related to an allowed topic (e.g., entertainment and film).

Similarly, in interactive toy applications, if a child places a superhero figurine on an interactive playset and requests a story, the topic check ensures that the generated narrative includes content within allowed themes such as problem-solving, or adventure. The pre-loaded query context for the topic check varies, in some embodiments, depending on the specific character/synthetic user being portrayed/emulated to ensure that AI-generated dialogue remains consistent with the established personality and values associated with that character.

In some embodiments, topic checks are executed individually and in parallel (e.g., each topic, serial killers or otherwise, is independently evaluated), and in some embodiments, multiple topics are screened simultaneously with one set of pre-loaded query context. A similar principle applies to other validation models 106a through 106n described below.

In some embodiments, one of the validation models 106a through 106n includes a localization check. The pre-loaded query context for the localization check includes geospatial data in a standardized format. The geospatial data includes latitude and longitude coordinates, country codes, region identifiers, and/or other location-specific information. Through geospatial algorithms, the model assesses whether the generated content remains relevant and appropriate for the geographic location of the users or user profiles initiating the query, using techniques such as coordinate-based calculations and geofencing. For example, the validation model 106a through 106n uses geofencing to check if the user's location falls within a predefined area, such as a city, state, or country, by defining a polygonal boundary using a series of latitude and longitude points and determining if the user's coordinates lie within this polygon.

Appropriateness is structured either as cultural awareness or cultural taboo. In such cases, the pre-loaded query context includes variables that are determined by the location of the user (e.g., language preferences, religious practices, social etiquette, historical context). An example pre-loaded query context is “Is topic X (as received from the user input) a polite topic for general discussion in Geographic region Y (country, state, metro area, etc. of the user).” Or similarly, “Is topic X (as received from the user input) something that people in Geographic region Y (country, state, metro area, etc. of the user) are familiar enough for a trivia question of difficulty Z (easy, medium, hard, etc.).”

In some embodiments, one of the validation models 106a through 106n includes a hallucination check. The pre-loaded query context for the hallucination check specifies parameters for evaluating data veracity and coherence to enable the check to use techniques such as sequence-to-sequence modeling and attention mechanisms. If the model detects a deviation from established criteria, indicating potential hallucination (i.e., generating information that is not based on the input data), the model interrupts the current output generation process and invokes the generative AI engine to restart. The hallucination check operates on the premise that generative AI output is produced on a per-character basis where the AI is predicting the next character in a given output as the output is being produced. Interrupting the main model, or requesting the main model start again from the middle of a given output causes the model to re-evaluate a given output from an intermediate position of the output (e.g., “try again from here”) and reduces model hallucination.

In some embodiments, one of the validation models 106a through 106n includes a profanity check. In some embodiments, profanity check integrates NLP techniques like part-of-speech tagging and sentiment analysis and is equipped with a pre-loaded query context that includes a comprehensive list of profane language and associated indicators. Part-of-speech tagging assigns a part of speech (e.g., noun, verb, adjective) to each word in a sentence based on the word's definition and surrounding context to identify the grammatical structure of the text. Sentiment analysis determines the emotional tone behind a body of text to gauge the likelihood of the content inducing profane language. The pre-loaded query context enables the profanity check to identify instances of profanity within the generated content or determine the likelihood for the content to provoke profane responses.

In some embodiments, one of the validation models 106a through 106n includes a jailbreak check. The pre-loaded query context for the jailbreak check is tailored to identify instances where a user attempts to manipulate the model by employing obscure or nonsensical queries. In some embodiments, the jailbreak check is accomplished using pattern recognition algorithms or anomaly detection techniques. For example, the jailbreak check identifies regularities and patterns in data and detects unusual or suspicious input patterns that deviate from normal usage, such as repetitive phrases, unusual syntax, or attempts to exploit known vulnerabilities.

An example of a pre-loaded query context employed to avoid jailbreaking is the query, “Is user input X typically considered human comprehensible speech?” Where the expected user input is always expected to be human-comprehensible, user input that is not decipherable by humans is anticipated to be an attempt at jailbreaking the main model.

In some embodiments, one of the validation models 106a through 106n includes an accuracy check. The pre-loaded query context for an accuracy check evaluates the factual correctness and authenticity of the output generated by the AI engine. In some embodiments, the check parses the generated output, extracts factual claims, and compares the factual claims against a structured database of verified information. For example, a classifier trained on labeled datasets of factual and non-factual statements are used to detect claims using features such as a presence of named entities, specific syntactic patterns, and/or certain keywords or phrases indicative of factual statements. The accuracy check queries the knowledge bases to validate that the generated content aligns with established facts.

An example of a predefined query context employed to determine accuracy is to employ output from one model in a query that requests “Is model output X factually supported?” Where the pre-loaded query context is employed in the context of a trivia game, the output is a question and a set of answers, some of which are intentionally false. In such circumstances, an example pre-loaded query context is, “Does exactly one of the possible answers X factually answer question Y?” Other checks include determining whether each potential answer is distinct from other potential answers. That is, is each available answer distinctive from the other. In some embodiments, the distinctiveness of the answers depends on the intended difficulty of the question. For example, a question that referred to the main antagonist of the Zelda game franchise might refer both to Ganon and Ganondorf. These answers refer to the same individual in different states. A more difficult question would distinguish between the states whereas an easy question should not.

In the context of interactive toys, the accuracy check verifies that narrative elements or visual representations (such as animation sequences) generated by the AI model are consistent with established character lore or otherwise established context/information. For example, the accuracy check validates that AI-generated stories maintain consistency with the official character canon and thus reduce contradictions that confuse users or misrepresent the character. The validation model(s), in some embodiments, cross-reference generated content against databases of character information, including personality traits, relationships, abilities, historical storylines, and so forth.

In some embodiments, one of the validation models 106a through 106n includes a format check. The format check is equipped with a pre-loaded query context that establishes specific formatting standards for the generated content (e.g., proper punctuation, correct capitalization, consistent spacing, and other specified formatting standards). The check ensures that the output from the generative AI engine adheres to these predefined formatting guidelines.

In some embodiments, one of the validation models 106a through 106n includes a user feedback check. In some embodiments, the pre-loaded query context includes user ratings, comments, preferences, and other relevant feedback elements. In some embodiments, the check leverages user-provided feedback through sentiment analysis (e.g., to determine the overall sentiment (positive, negative, or neutral) expressed by the users) or collaborative filtering techniques (e.g., to predict interests of a user by collecting preferences from other users) to assess the quality and effectiveness of the trivia questions and answers. The user feedback check identifies patterns in user feedback, such as frequently liked or disliked questions. For example, if multiple users rate a question poorly and leave negative comments, the user feedback check refines or replaces the problematic question.

In some embodiments, one of the validation models 106a through 106n includes a difficulty level analysis check. The pre-loaded query context for the difficulty level analysis check analyzes the complexity of the generated content, ensuring that the generated content aligns with the cognitive capabilities and knowledge levels of the intended users. For example, the difficulty level analysis check uses one or more classifiers (e.g., decision trees) to determine the complexity of content by evaluating various attributes such as vocabulary difficulty, sentence structure, and topic familiarity. In some embodiments, results from different classifiers are aggregated to provide an overall assessment of content difficulty. Each classifier generates a difficulty score based on the classifier's specific criteria (e.g., word length, syntactic complexity, and so forth). The individual scores are aggregated using methods such as weighted averaging, where different weights are assigned to each classifier's score based on the classifier's importance and/or reliability, or a voting mechanism, where each classifier votes on the difficulty level and the final level is determined by the majority vote or other consensus mechanism. For example, if the intended users are middle school students, the difficulty level analysis check rejects questions pertaining to quantum physics.

In some embodiments, one of the validation models 106a through 106n includes a temporal relevance check. The pre-loaded query context for the temporal relevance check enables the check to evaluate whether the generated content remains pertinent and up-to-date in relation to the prevailing temporal context. In some embodiments, techniques such as temporal analysis or trend prediction algorithms are used. For example, the temporal relevance check examines time-related aspects of the content, such as publication dates, event timelines, and the currency of information, to ensure that the content is still relevant. For example, if the content includes references to technological advancements, the model will verify that the references are current and not outdated. Similarly, for content related to ongoing events, the model will ensure that the information reflects the latest developments.

The validation models 106a through 106n, each equipped with a distinct pre-loaded query context, validate the data received by the content receiving module 102. The query context dictates which kind of uncertainty or variability the particular validation model is measuring. For example, if the validation models 106a through 106n included a topic check, localization check, and profanity check, the consensus module 108 will validate the data received by the content receiving module 102 only if the data is not on the deny list of topics, appropriate for the geography of users or user profiles, and does not have instances of profanity, respectively.

Reference to AI models herein employs either platform native models or external application program interfaces (APIs). External APIs (e.g., ChatGPT, MidJourney, Llama, Bard, etc.) are communicatively coupled to a game platform. The pre-loaded query context is initially configured by a game platform. At least in circumstances where the AI models are accessed through external APIs, the pre-loaded query context remains stored with the game platform and is delivered to the validation models 106a-106n when triggered.

In some embodiments, the consensus module 108 then receives the output of the validation models 106a through 106n and validates the data received by the content receiving module 102 if the plurality of checks performed by the validation models 106a through 106n returns a positive result. If any one of the validation models 106a through 106n returns a negative result, the consensus module 108 will not validate the validation models 106a through 106n. In some embodiments, the consensus module 108 validates the data received by the content receiving module if the number of positive results exceed a certain threshold (e.g., percentage, number of validation models 106a through 106n). In some embodiments, each of the validation models 106a through 106n are assigned a particular weight (e.g., the accuracy check is weighed more heavily than the difficulty check), and the consensus module 108 validates the data based upon the aggregated weight of positive results exceeding a threshold value.

In some embodiments, the consensus module 108 is equipped with a load-balancing algorithm, which dynamically allocates processing resources among the validation models 106a through 106n. In some embodiments, the load-balancing algorithm takes into account factors such as algorithmic intricacy, data volume, or computational intensity. In some embodiments, the load-balancing algorithm dynamically monitors the current system load by tracking metrics like central processing unit (“CPU”) utilization, memory usage, and I/O operations in real-time to make informed decisions regarding the allocation of processing resources. Furthermore, in some embodiments, the algorithm considers the urgency of validation checks. For instance, time-sensitive validations are prioritized over tasks with less immediate relevance, ensuring that critical content assessments are conducted promptly.

In some embodiments, the load-balancing algorithm has knowledge of the volume of data sent and the size of each query, but lacks control over the model's underlying parameters. Thus, the load balancer optimizes the queries in terms of their size, speed, and operations, but cannot directly influence the model's internal workings. In such a case, for example, instead of delivering a batch of ten questions to the validation module 104 at one time, the load-balancing algorithm chooses to send ten separate queries to the validation module 104, one for each question, allowing parallel execution.

In some embodiments, the algorithm takes into consideration the contextual intricacies accompanying each question, gauging factors such as query complexity or time sensitivity. For example, when the user is actively waiting on the generating questions, the system may opt for a more parallelized, one-per-query validation approach such that the game platform delivers questions as each individually becomes cleared/available. Conversely, during moments when the user is preoccupied and the game has available processing time, the load-balancing might choose to validate multiple questions within the same query to a given validation model.

In some embodiments, there is a response mechanism to help the load-balancing algorithm determine the algorithm's course of optimization. Based on an assessment of the query's size and context, and/or a current game state, the response mechanism decides whether it's advisable to divide the query into smaller, more manageable segments. For example, where ten questions are sent for validation, and six of them fail to meet the checks conducted by the validation models 106a through 106n, a response mechanism is triggered. The time the user takes to answer the four successfully validated questions creates a window of opportunity for the system to generate replacements for the remaining six. In this example, there is potential to process all six replacements simultaneously. However, in a scenario where nine out of ten questions fail the checks conducted by the validation models 106a through 106n, and only one question buffer is available, a faster approach is warranted. In this case, the system may opt to validate questions one at a time in parallel, ensuring that by the time the user answers all presently available successfully validation questions, there are further successfully validated questions available.

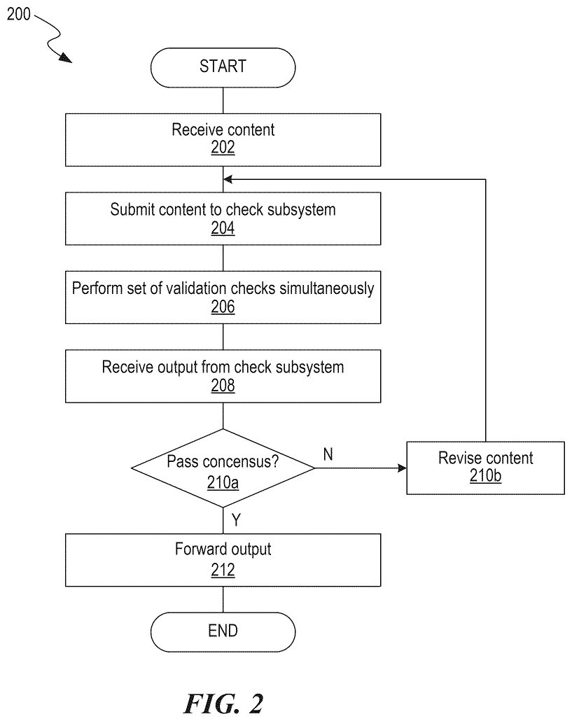

FIG. 2 is a flowchart illustrating a method 200 of performing the validation process in FIG. 1. In some embodiments, the method 200 is performed by a system including components of the example computing environment/computing system 1100 illustrated and described in more detail with reference to FIG. 11. The system is implemented on a terminal device, on a server, and/or on a telecommunications network core. Likewise, embodiments can include different and/or additional operations or can perform the operations in different orders.

The process initiates with the reception of content in operation 202. In some embodiments, the content consists of either a user-requested topic or a question and the question's corresponding answer. For example, the content is the output of a generative AI engine employing a neural network-based architecture. In some embodiments, the content encompasses the subdivided output of a model. For instance, if the model generates a set of 10 trivia questions, each of these questions is individually subjected to parallel validation, allowing for independent assessment rather than being processed as a collective group, thereby improving processing speed.

Subsequently, the received content is submitted to a check subsystem in operation 204. Once in the check subsystem, operation 206 determines the content's compliance with a predetermined model-driven condition. In some embodiments, the predetermined model-driven condition is predetermined by the pre-loaded query context. For example, a predetermined model-driven condition is that the content cannot fail one or more specific validation checks, such as a hallucination check, profanity check, localization check, and jailbreak check.

A parallel processing mechanism executes a set of independent validation models simultaneously in operation 206 to complete the validation checks, returning the results of the independent validation models in operation 208. By doing so, the system significantly expedites the completion of validation checks, resulting in a streamlined and expeditious assessment of the received content. In some embodiments, the parallel processing mechanism utilizes a load-balancing algorithm that dynamically allocates processing resources among the independent validation models in response to computational demand. In certain embodiments, the load-balancing algorithm takes into account various factors, such as the complexity of the validation models, the current computational load on the system, and the urgency of the validation checks as discussed in further detail with reference to FIG. 1.

In operation 210A, the outputs received from the check subsystem in operation 208 are validated through a decision point (i.e., consensus check performed by consensus module 108 with reference to FIG. 1). In some embodiments, upon encountering a failed consensus check, the content is revised in operation 210B. In one example, the system opts for content discarding. In such embodiments, the game either requests additional content or relies on already available and stored content. Where additional content is requested, the game platform makes use of generative techniques to obtain revised content, such as generative adversarial networks (“GANs”) or recurrent neural networks (“RNNs”). In another example, the system prompts alternative validation approaches such as parameter adjustments (e.g., varied query context) to produce revised outputs from the validation models 106a through 106n. In another example, where the content is a user input, a game GUI signal is issued, signifying the need for new user input.

The revised content generated in operation 210B is then directed back to operation 204. Here, a new iteration of the content generation process is initiated. The revised content is subjected to the same validation process. In instances where the revised content still does not attain consensus, in some embodiments, the system iterates through the re-validation process multiple times until consensus is achieved or a predefined threshold for revision attempts is reached.

Upon successful validation, the content is obtained. Successful validation signifies that the content has met the required criteria. In some embodiments, the content is forwarded to a front-end interface in operation 212. The front-end interface serves as the interface through which the user interacts with the system. In some embodiments, the front-end interface encompasses visual or auditory elements to facilitate user engagement. In operation 212, depending on the specific context and user preferences, the system chooses to disclose either the question or the question's corresponding answer, catering to individual user needs or preferences.

### Validating Game Systems

The disclosed architecture is designed to integrate with a trivia game environment, ensuring that user-generated inputs align with predefined content guidelines and maintain a high standard of accuracy and relevance. The tailored framework addresses the unique challenges posed by the trivia game context, where the accuracy of questions and answers is paramount to the overall gameplay experience.

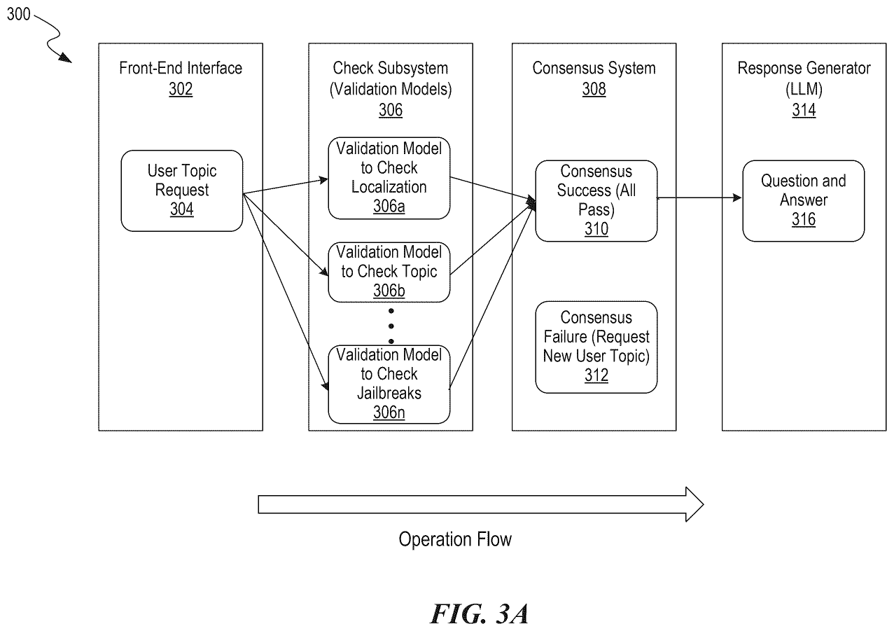

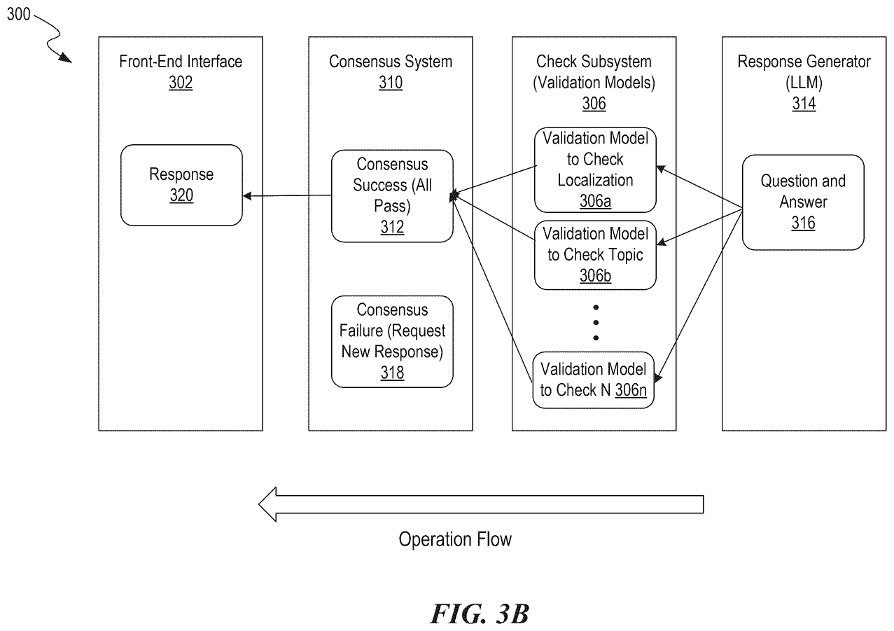

FIG. 3A is a diagram illustrating one embodiment of the architecture of the validation framework 300 as applied to validating user inputs in a trivia game. The validation framework 300 (same as or similar to the validation framework 100 in FIG. 1) includes a front-end interface 302, a topic 304, validation models 306 (e.g., a first validation model 306a, a second validation model 306b, and so forth), a consensus system 308, consensus success 310, consensus failure 312, response generator 314, and question and answer 316. The validation framework 300 is implemented using components of example computer system 1100 illustrated and described in more detail with reference to FIG. 11. Implementations of the validation framework 300 can include different and/or additional components or can be connected in different ways.

In some embodiments, the validation framework operates beginning with the front-end interface 302. The user will request a topic 304. For example, the user requests a certain topic (e.g., “Kangaroos”). The user-requested topic 304 is then scrutinized under a check subsystem, which includes, in some embodiments, validation models 306. In other embodiments, the validation models 306 includes a set of independent validation models 306a through 306n. The set of independent validation models 306a through 306n each checks the user-requested topic 304 to determine whether the user-requested topic 304 complies with the consensus criteria. In some embodiments, each of the set of independent validation models 306a through 306n is equipped with the model's own unique validation capabilities, bolstering the overall assessment process.

As described above, in some embodiments, the set of independent validation models 306a through 306n is executed simultaneously. By leveraging parallel processing, the framework significantly expedites the check subsystem, enhancing the responsiveness of the system. In some embodiments, the parallel processing capability of the architecture is facilitated by concurrent execution threads at each node, leveraging multi-core processing capabilities of the underlying hardware.

Subsequent to the independent validation phase, the user-requested topic 304 is channeled into a consensus system 308. The consensus system 308 ensures that only the user-requested topic 304 that meets the consensus criteria proceeds to the next stage.

In some embodiments, there are two possibilities once the user requested topic 304 enters the consensus system 308. The first possibility is that the user-requested topic 304 meets consensus criteria (e.g., consensus success 310). The second possibility is that the user-requested topic 304 fails one or more of the consensus criteria (e.g., consensus failure 312). If the user-requested topic 304 meets the consensus criteria (e.g., consensus success 310), the user-requested topic 304 is directed towards the response generator 314. In some embodiments, there is a model superstructure between the response generator 314, the front-end interface 302, and the validation models 306. In some embodiments, the front-end interface 302 stands as the initial node, acting as the ingress point for the user topic 304.

In some embodiments, the response generator 314 includes a neural network-based architecture, such as an LLM. In some embodiments, the response generator is a generative AI model that operates as a deep neural network (“DNN”) with multiple layers of long short-term memory (“LSTM”) cells. The cells facilitate sequence-to-sequence processing, enabling the model to comprehend and respond to user input with a contextual understanding of various applications, such as trivia games or Ouija board sessions. For example, a response generator 314 generates a question and answer 316 in response to the user topic 304. On the other hand, if the user-requested topic 304 does not meet the consensus criteria, the consensus system 308 fails and a new topic is requested 312 from the user through the front-end interface 302. For example, in cases where a user includes explicit language or offensive content in their input, the profanity check would identify the content and reject the input. In another example, if a user attempts to bypass the system by inputting a series of random characters, the jailbreak check would recognize the input as an attempt to manipulate the system and prompt a revision.

FIG. 3B is a diagram illustrating one embodiment of the architecture of the validation framework 300 as applied to validating language model outputs in a trivia game. In some embodiments, there is a model superstructure between, the front-end interface 302, the check subsystem (e.g., validation models 306), and the response generator 314. In some embodiments, the response generator 314 stands as the initial node, acting as the ingress point for the generated question and answer 316. In some embodiments, the response generator 314 is responsible for generating a question and answer 316. The question and answer 316, in some embodiments, is a generated trivia question and answer using a generative AI engine. The response generator 314 responds dynamically to user requests, creating questions that are pertinent to the specified topics. For example, if the user requests a certain topic (e.g., “Kangaroos”), the response generator 314 will respond with a question related to the user-requested topic (e.g., “What is a group of kangaroos called?”), and also include the answer, ensuring that each question is paired with a correct and contextually appropriate answer (e.g., “Mob”).

The generated question and answer 316 is then dispatched along the established pathways of the communication structure to the check subsystem (e.g., validation models 306). In some embodiments, the response generator is a generative AI model that operates as a deep neural network (DNN) with multiple layers of LSTM cells. These cells facilitate sequence-to-sequence processing, enabling the model to comprehend and respond to user input with a contextual understanding of various applications, such as trivia games or Ouija board sessions.

The question and answer 316 is then scrutinized under validation models 306, which, in some embodiments, includes one validation model 306. In other embodiments, the validation models 306 includes a set of independent validation models 306a through 306n. The set of independent validation models 306a through 306n each checks question and answer 316 to determine whether question and answer 316 complies with the consensus criteria. In some embodiments, each of the set of independent validation models 306a through 306n is equipped with the model's own unique validation capabilities, bolstering the overall assessment process.

As described above, in some embodiments, the set of independent validation models 306a through 306n is executed simultaneously. By leveraging parallel processing, the framework significantly expedites the check subsystem, enhancing the responsiveness of the system. In some embodiments, the parallel processing capability of the architecture is facilitated by concurrent execution threads at each node, leveraging multi-core processing capabilities of the underlying hardware.

Subsequent to the independent validation phase, the question and answer 316 is channeled into a consensus system 308. The consensus system 308 ensures that only a question and answer 316 that meets the consensus criteria proceeds to the next stage.

If the question and answer 316 meets the consensus criteria (e.g., consensus success 310), the question and answer 316 is directed toward the front-end interface 302. The front-end interface 302 serves as the bridge between the system and the user, providing a platform for user interaction with the trivia game and displaying the question and answer 320 generated by the question and answer generator 314. In some embodiments, the front-end interface 302 includes visual elements, auditory cues, and user prompts to facilitate an engaging experience. On the other hand, if the question and answer 316 does not meet the consensus criteria, the consensus system 308 fails and a new question and answer is requested 316 by the question and answer generator 314 or the user.

For example, if the question and answer generator 314 generates a question and answer 316 asserting that Paris is the capital of Germany, the accuracy check would fail, as the statement is factually incorrect. In another example, if a generated question and answer contains explicit or offensive language, the profanity check would fail. In another example, if the output were to contain fabricated information, such as claiming that unicorns are real animals, the hallucination check would identify the output as false data. In another example, if a user inputs trivia questions suitable for children but receives questions at an advanced academic level, the difficulty level analysis check would fail.

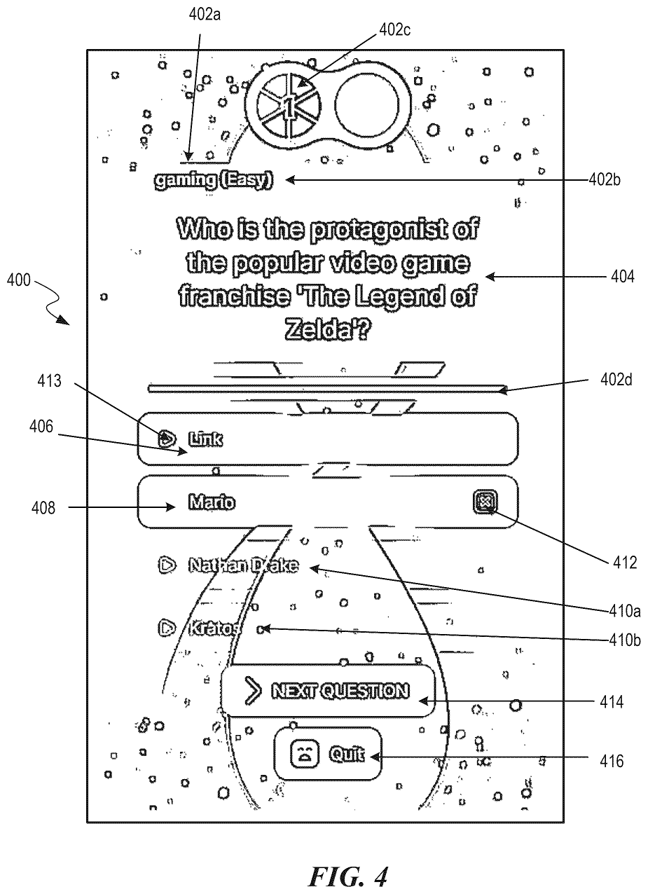

FIG. 4 is a screenshot of one embodiment of the front-end interface 400 as applied to a trivia game. In some embodiments, the front-end interface 400 includes headers 402. In some embodiments, the headers 402 include a variety of information helpful to the user, such as the user-requested topic 402a or the difficulty level of the trivia game 402b. Further headers include, but are not limited to: 1) a timer 402d that displays the remaining time for answering each question, and 2) a progress indicator 402c graphically represents the user's advancement through the trivia game, providing a tangible sense of achievement and urgency.

A question 404 is displayed on the front-end interface 400. In some embodiments, below each question 404, a set of answer options (406, 408, 410a, 410b) is presented, allowing users to select their preferred answer by clicking or tapping the corresponding option. Additionally, in some embodiments, one or more supplementary features like a leaderboard, social sharing options, or in-game chat functionality are integrated into the interface, depending on the game's design. Once the user submits their answer, the incorrect answer 408 is highlighted with a second visual icon 412, and similarly, the correct answer 406 is highlighted using a first visual icon 413. In some embodiments, selected answers 406 are visually highlighted for clarity. In some embodiments, there is a progression button 414 that enables users to advance to the next question, ensuring a fluid and uninterrupted gameplay experience. In some embodiments, there is a quitting button 416, configured so that the user is enabled to leave the gaming experience at any time.

### Synthetic Users

A synthetic user is where the generative AI takes on a role and engages in a back-and-forth interaction with the user (e.g., a chat). The model is governed by a pre-loaded query context indicating what role the main model is to take on. In some embodiments, input, and output to the synthetic user are treated in a similar fashion as described above with respect to validator models.

In some embodiments, the generative AI model that is configured as a synthetic user is communicatively coupled with a graphic user interface to enable a user to interact. The output of the synthetic user is employed to govern the graphic user interface. Embodiments of the graphic user interface directly display the synthetic user output, use the output as commands to a game platform, and/or cause animations to play.

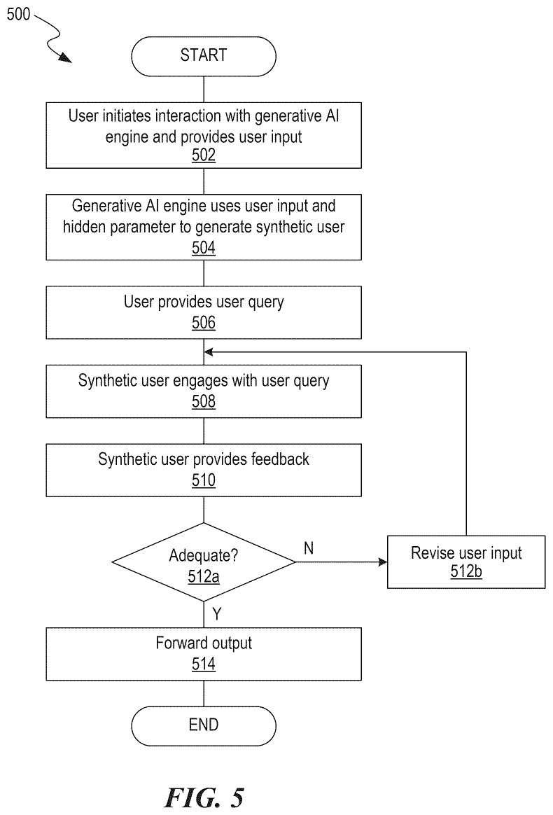

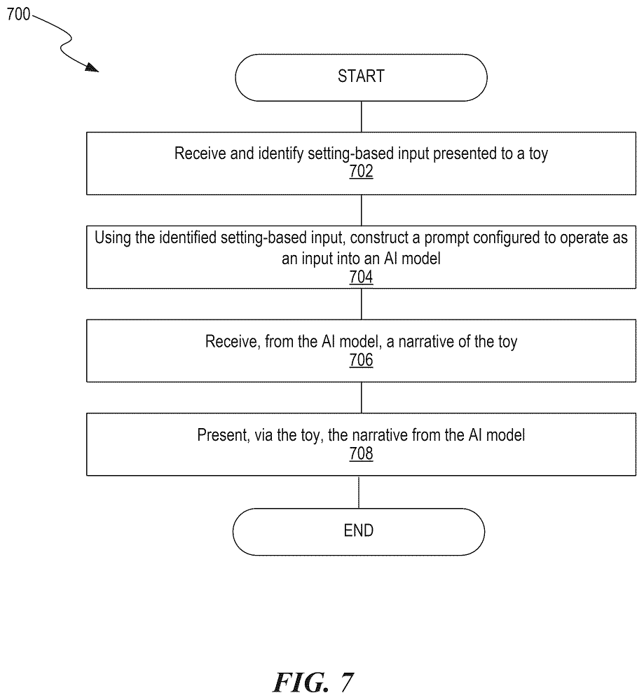

FIG. 5 is a flowchart illustrating an example method 500 of implementing a synthetic user. The process initiates with user initiating interaction with a generative AI engine by providing user input in operation 502. The input serves as a directive, guiding the generative AI engine in the engine's synthetic user creation process. For example, some user input examples are “Ouija board,” “Peppa Pig,” “Optimus Prime,” “Deadpool,” “banana,” “wall,” and so on. In some embodiments, in the context of a virtual Ouija board session, the synthetic user is the Ouija board, obviating a need for user input in operation 502. In another embodiment, in the context of a toy (discussed further in FIG. 7), the synthetic user is the character depicted by the toy (e.g., Deadpool, a banana), also obviating the need for user input in operation 502.

The generative AI engine, in turn, interprets and processes the input, and generates parameters of a synthetic user in operation 504. In some embodiments, the parameter is hidden from the user. The hidden parameter, while not explicitly specified in user input, enables the model to produce content that adheres to the specific characteristics dictated by the designated virtual character role. In some embodiments, the hidden parameter functions in the same way as a pre-defined query context, further detailed in FIG. 1. Both the pre-defined query context and the hidden parameter guide the generated responses based on predetermined model-driven conditions.

For example, a user input is received in operation 502 from a participant belonging to a “Carefree Competitors” market segment. The hidden parameter, not able to be modified by the user, characterizes the “Carefree Competitors” market segment by individuals between the ages of four through twelve who share an affinity for straightforward, engaging games with brisk gameplay. The hidden parameter further includes that, much like the classics including Jenga, Twister, or Guess Who, the group prioritizes activities that are lively, stimulating, and require minimal contemplation for the next move. For example, hidden parameter prefers gaming sessions that typically span less than an hour, and places emphasis on the enjoyment derived from gameplay rather than the ultimate outcome. In this case, synthetic user in operation 504 would encompass the characteristics given by the hidden parameter and respond in a way that aligns with the characteristics given by the hidden parameter.

In another example, where the synthetic user is an Ouija board and is functioning as the embodiment of a deceased individual, the hidden parameter instructs the synthetic user to respond to inquiries with an air of ambiguity and mystique, utilizing a restricted vocabulary of letters and numbers, and adhering strictly to concise, one-to-two-word responses. For example, in the context of an Ouija board game, where a user input is “I summon the spirit of Leonardo da Vinci. Please share your knowledge with us,” the generative AI engine generates responses in a manner consistent with the specific attributes associated with Leonardo da Vinci, who is the designated virtual character role. The specific attributes associated with Leonardo da Vinci (e.g., expert in painting, lived in the Renaissance era, Italian) will be defined in the hidden parameter.

The synthetic user, in some embodiments, is an inanimate object. Inanimate objects (e.g., a plate of caviar, a banana, a wall) each include personality traits either pre-defined by the hidden parameters or assigned by an AI model. For example, the plate of caviar includes personality traits of sophistication and exclusivity, responding with witty remarks like, “Honey, if you have to ask, you can't afford me,” reflecting the plate of caviar's luxurious persona. The system inputs a prompt (e.g., a prompt) to an AI model to assign a set of personality traits and/or the corresponding voice to the inanimate object. For example, the system queries an AI model with a prompt such as “You are a plate of caviar. What are the characteristics of the voice you would have?” to receive characteristics such as “a sophisticated voice with a British accent.” Since the personality traits of the inanimate objects are queried through an AI model, inanimate objects of the same type may have different personalities. For example, one banana may be a stand-up comedian, whereas another banana may be a CEO. The non-deterministic nature of the AI-generated personalities provides engaging gameplay.

In some embodiments, the parameters encompass attributes related to emotional states. These emotional nuances, ranging from serenity to apprehension, are dynamically inserted into the responses. Further, in some embodiments, the parameters encompass predefined personality traits, allowing the generative AI engine to craft responses in accordance with the character traits embedded within the designated virtual character role. Predefined personality traits ensure that the responses align with the character's disposition, whether the disposition be assertive, compassionate, mysterious, or other defined attributes, adding depth and consistency to the interaction. Additionally, in some embodiments, the parameters encompass linguistic nuances, permitting the generative AI engine to adopt specific language styles, dialects, or colloquialisms associated with the designated virtual character role.

In some embodiments, the parameters encompass contextual adaptability. Contextual adaptability enables the generative AI engine to dynamically adjust the generated feedback based on ongoing conversation or specific situational cues. The model attunes itself to the evolving context, ensuring that the responses remain relevant and coherent within the given interaction. Moreover, in some embodiments, the parameters incorporate specific cultural or demographic attributes, aligning the generated feedback with the preferences and expectations of a designated target audience.

In some embodiments, after processing the user input to generate the synthetic user in operation 504, the generative AI engine is equipped to output an assessment of the classification with or without further user input. The assessment serves as a valuable validation mechanism, providing users with insights into the engine's generation of the synthetic user in operation 504. For instance, the engine indicates a high confidence level in the classification, signifying that the attributes assigned to the synthetic user closely match the provided information. Alternatively, the engine acknowledges/identifies potential areas of uncertainty or ambiguity in the classification, prompting users to review and, if necessary, refine the input for a more precise representation. The dynamic feedback loop ensures that the synthetic user's classification aligns as closely as possible with the user's intended profile.

Using the above example regarding the “Carefree Competitor” market segment, if the engine's classification indicates that around 78% of the “Carefree Competitor” market typically engage in games for less than an hour, and the figure contrasts with the user's expectation, the user is able to revise the synthetic user's classification by varying the characteristics in the user input, ensuring the synthetic user accurately mirrors their specific circumstances and preferences.

Subsequently, the user provides a user query in operation 506. In some embodiments, a user query is in the form of a question. In some embodiments, the query is a visual and/or auditory input. For example, a game developer would submit a rendering of the main character for the synthetic user to evaluate, or a sample of the music to be used in the game to ensure that the generated content is suitable for their target audience.

Next, in operation 508, the synthetic user engages with the user query provided in operation 506 and provides feedback in operation 510. In some embodiments, when a user initiates interaction by providing a query in operation 506, the generative AI engine processes the input through a series of specialized models that encompass linguistic and behavioral characteristics specific to the synthetic user and ensure that the feedback aligns with the synthetic user's characteristics. In some embodiments, the generative AI engine leverages advanced NLP techniques to craft responses that mirror the cognitive and linguistic abilities of the synthetic user.

In some embodiments, the provided feedback is first scrutinized under a check subsystem, which includes a set of independent validation models. The set of independent validation models each checks the feedback to determine whether the feedback complies with the consensus criteria. In some embodiments, each of the set of independent validation models is equipped with the model's own unique validation capabilities, bolstering the overall assessment process. In one example, if the feedback is about a historical event that is factually incorrect, such as stating that Abraham Lincoln was not the 16th President of the United States, the check subsystem would fail the accuracy check. In another example, if the feedback incorporates a number of special characters or symbols, such as “@n$w3r,” the format check would fail.

The system, in some embodiments, checks the feedback for safety and moderation purposes. For example, the system implements a ban list to filter out inappropriate or sensitive content. The ban list is accessed through an Application Programming Interface (API). In another example, a proactive approach involves intercepting feedback and sending the feedback to an AI model for rewriting to ensure that the resulting content adheres to predetermined rating standards (e.g., Motion Picture Association film rating system). The rewriting process is a safeguard to prevent the generation of content that violates safety guidelines or community standards. The cleansed version of the input is then sent back to the system to present to the user, ensuring that only appropriate and sanitized content is generated and shared with users.

In some embodiments, the feedback received from the synthetic user in operation 508 is validated through a decision point in operation 512A. In some embodiments, if the user decides that the synthetic user's feedback is adequate, the method ends. In other embodiments, if the user decides that the synthetic user's feedback is inadequate, the user is enabled to revise the user query in operation 512B. The revised content generated in operation 512B is then directed back to operation 508. Here, a new iteration of the synthetic user feedback is initiated. The revised content is subjected to the same evaluation by the synthetic user.

In operation 514, the output is forwarded. In some embodiments, the output from the validation models is communicatively connected to an animation engine. The animation engine generates an animation to be graphically displayed on the user interface based on instructions from the validation models or main model. In some embodiments, the animation engine is not an AI engine itself, but rather a scripted animator (generates animations based on predefined scripts but based on instructions from the output of AI models).

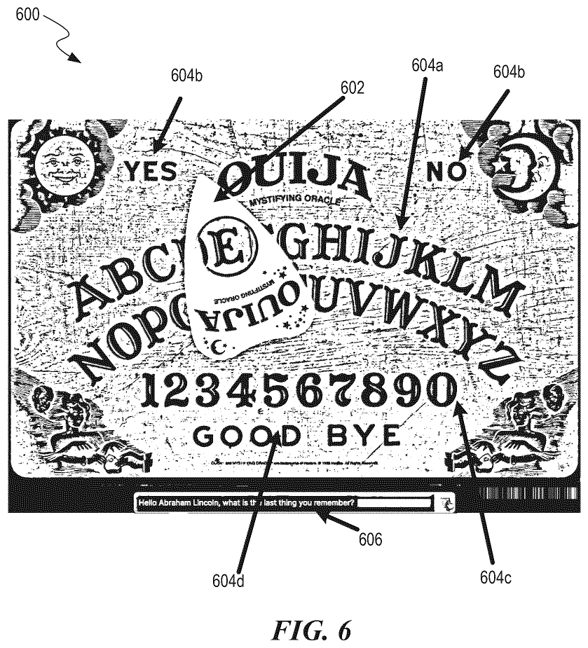

FIG. 6 is a screenshot of one embodiment of the front-end interface of a synthetic user as applied to an Ouija board game.

The interactive element within the disclosed Ouija board 600 is the planchette 602. The planchette 602 serves as the conduit for user interaction with the supernatural realm. In some embodiments, users employ the planchette to select letters, numbers, or other indicators, facilitating communication with the otherworldly entities.

In some embodiments, the depiction of the Ouija board itself includes, but not limited to, the customary arrangement of letters 604a, “Yes” and “No” indicators 604b, numbers 604c, and the “Good Bye” indicator 604d. In some embodiments, as users engage with the Ouija board 600, subtle visual effects, such as faint glowing or shadowy apparitions, accompany the movement of the planchette. In some embodiments, carefully curated auditory cues are included, like whispers or ethereal sounds, further heightening the immersive experience, and adding a sensory dimension to the gameplay. To provide users with a sense of continuity and progress within the mystical communication process, a visual indicator, is represented by a message bar 606 so that the user inputs the message they want the board to answer.

Within the disclosed Ouija board 600, the integration of a synthetic user adds a layer of sophistication to the interactive experience. The synthetic user, powered by a generative AI engine, serves as an intelligent counterpart to the human participant, enabling dynamic and responsive interactions. The synthetic user's role is particularly pronounced in tandem with the planchette 602, as the planchette collaborates with the human user to facilitate communication with the supernatural realm. As the human user guides the planchette 602 across the Ouija board 600, the synthetic user complements these movements with intuitive and contextually relevant responses. Through the integration of natural language processing and contextual understanding, the synthetic user generates messages that align with the thematic essence of the Ouija board game. For example, the user requests a certain question (e.g., “Abraham Lincoln, what is the last thing you remember?”), and the response generator 314 responds with an answer related to the user-requested topic (e.g., “THEATER”).

In some embodiments, the messages encompass cryptic phrases, enigmatic clues, or ethereal insights, effectively heightening the immersive experience. The synthetic user's interactions are synchronized with the planchette 602 movements, creating a fluid and coherent exchange between the human user and the supernatural realm. The synthetic user's contributions extend beyond mere responses; the synthetic user also augments the visual or auditory effects associated with the planchette's 602 movements. By dynamically influencing these effects in response to user interactions, the synthetic user improves the overall ambiance, imbuing the experience with an extra layer of mystique and intrigue.

Synthetic Users within Physical Toys

FIG. 7 is a flowchart illustrating an example method 700 of implementing the synthetic user through an interactive toy (e.g., model). In some implementations, the method 700 is performed by components of example computer system 1100 illustrated and described in more detail with reference to FIG. 11. Likewise, implementations can include different and/or additional steps or can perform the steps in different orders.

In operation 702, the system receives and identifies input content (e.g., setting-based content associated with a storytelling environment) presented to a toy. A toy refers to a physical manifestation of a synthetic user/character (e.g., Peppa Pig, Deadpool) or an inanimate object with an attached connected device (e.g., banana, wall, plate of caviar) able to generate narratives and/or engage in interactive conversations with the user. Further examples of synthetic users are described with reference to FIG. 5 and FIG. 6. In some embodiments, the toy is more than a static figurine, and is able to move, gesture, and respond dynamically to user inputs. For example, embedded emoters (e.g., motors, lights) are used within the toy create lifelike movements while the toy is presenting the narrative (e.g., mouth movements, eyebrow raises). Combining the physical presence with the dynamic narrative generation creates a more interactive storytelling environment.

An emoter refers to a physical device or component integrated within a toy that enables the toy to emote or express emotional states and narrative context through one or more forms of output. An emoter includes, for example, motors enabled to create physical movements such as facial expressions, gestures, or body positioning, lights enabled to present visual displays such as color changes, brightness variations, or blinking patterns, reflective surfaces enabled to redirect or manipulate light to create visual effects, heating/cooling elements enabled to present temperature variations, and other physical components enabled to generate expressive output that conveys emotional or narrative information to a user. The emoter may operate individually or in coordination with other emoters to create expressive sequences.

The input content includes, for example, environmental data captured by sensors (e.g., audio, visual, pressure, gyroscope, accelerometer) coupled to the toy, user-provided contextual information, pre-defined scenario parameters related to the storytelling environment, and so forth. The input content defines physical attributes of objects present in the storytelling environment and/or spatial relationships between the objects, and is introduced through one or more input methods such as a camera, NFC tags uniquely identifying the objects in the storytelling environment, and/or audio input. For example, the system identifies, from audio input, instructions that include verbal/oral commands or verbal/oral descriptions related to the storytelling environment.

When objects are introduced via a camera, the system uses image recognition technology to identify the objects. Identifying the objects involves capturing an image of the object (e.g., through an embedded camera within the toy), transmitting the image to a cloud-based AI model (e.g., LLM) and/or a localized model within the toy, and analyzing the image to determine the object's characteristics. In some embodiments, the AI model or localized model uses facial recognition and/or object recognition algorithms to identify characters and objects accurately. The system recognizes the shape, color, and other visual markers to identify the object.

For NFC-tagged objects, the system reads unique identifiers embedded in the tags when they are placed in front of the toy. Each NFC tag contains a unique ID that the system retrieves through a cloud-based application or through a locally stored database. The identifier is cross-referenced with a database to determine the specific characteristics and attributes of the object or figurine by mapping respective NFC tags of the data within the setting-based input to one or more entries in the database. For instance, an NFC tag identifies a character as a knight, and be associated with attributes such as bravery and a quest for adventure. Audio input allows users to introduce objects or provide commands/questions verbally. The system uses speech recognition technology to interpret the audio input, identify the referenced objects, use the referenced objects to generate a narrative reply. In some embodiments, the input is multi-modal and accept multiple inputs. For example, a user holds up a tennis ball in front of (or in proximity to) the toy and ask for the toy to “Tell me a story about this tennis ball.”

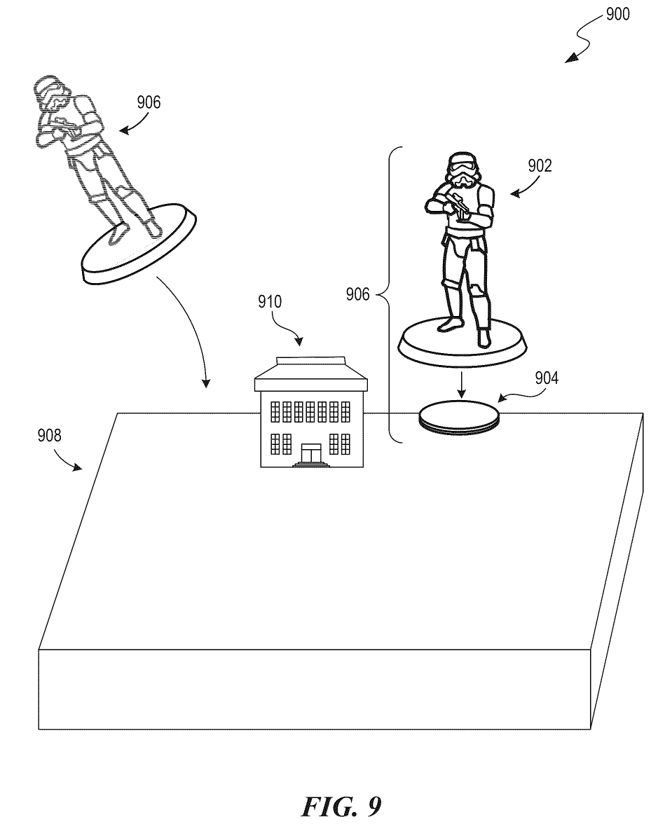

In operation 704, using the identified input content, the system constructs a prompt (e.g., command set, input, query) configured to operate as an input into an AI model. The prompt includes the identified input content while providing an instruction set for the AI model to generate relevant and coherent responses (e.g., a narrative segment for the storytelling environment). Examples of constructing command sets (e.g., populating templates, improvisational techniques) are described in further detail with reference to FIG. 9.

Elements of the prompt include various specific instructions to guide the AI model in generating the desired output. The elements include, in some examples, the context of the narrative, character details, and/or the nature of interactions to ensure that the output aligns with the intended narrative. Additionally, in some embodiments, the prompt includes content associated with the form and nature of the output. For example, if the desired output is in an audio format, the prompt specifies that the output should be in an audio format (e.g., such as a voice of a particular personality).

The command set, in some embodiments, includes at least one hidden parameter that causes the AI model to emulate attributes associated with one or more virtual character roles (e.g., synthetic personality, synthetic voice profile) corresponding to the objects (e.g., the synthetic user discussed with reference to FIGS. 5-8). For example, the character or object is associated with a virtual character role that defines specific behavioral patterns, speech characteristics, and/or narrative perspectives that the AI model emulates during narrative generation. The virtual character role, in some embodiments, is predefined and stored in association with the character or object identifier, or is dynamically generated/selected using the AI model based on the physical characteristics or context of the character or object. For instance, a figurine representing a banana is linked to a predefined virtual character role of a stand-up comedian that causes the AI model to generate dialogue using humorous language, comedic timing patterns, and joke-telling behaviors characteristic of comedian personas. In some embodiments, the AI model dynamically generates a virtual character role for the banana figurine based on the figurine's visual characteristics and assigns personality traits such as a cheerful disposition or energetic behavior patterns. This results in varied character roles that differ depending on the various environmental and contextual inputs provided to the AI model.

For example, an example prompt for a toy emulating Deadpool where the user holds a tennis ball in front of the toy is “You are Deadpool, tell me a story about a tennis ball, you are telling this to a large audience, your tone should be snarky.” In the example, the snarky tone and the large audience attributes are determined based on the character the toy is emulating (e.g., Deadpool). In another example, the prompt for a toy emulating Peppa Pig is “You are a story telling engine, your point of view is that from Peppa Pig. Tell a short story under 100 tokens. For the short story, tell me something exciting about the stars.” In the example, “exciting” and “the stars” are able to be extracted from user input, such as textual input, drop down menus, recorded audio input, preconfigured buttons, and so forth.

In some embodiments, the prompt includes a limit on the token size of the response from the AI model. For example, the limitation is a part of the model's initialization parameters within the prompt or dynamically adjusted based on the context of the interaction. For instance, in some embodiments, the AI model is instructed to generate up to 50 tokens per response only during high-intensity action scenes, which is able to be specified in the prompt, to ensure quick and punchy dialogues. The system dynamically adjusts the token limit based on the narrative context. Similarly, in some embodiments, detailed explanations or emotional dialogues allow for a higher token limit. The adaptability ensures that the narrative remains coherent and engaging across different scenarios by balancing the size of the AI model's output. In some embodiments, the system dynamically allocates system resources to generate the narrative segment based on the query complexity of the command set (e.g., the number of characters and objects present in the storytelling environment, the length of narrative history), the degree of time sensitivity of the command set (e.g., whether a user is actively waiting for a response), or the current computational load of the computing device (e.g., system metrics such as CPU utilization percentages, available memory capacity, network bandwidth usage). For example, a command set involving a single character figurine performing a basic action is classified as low complexity and allocated fewer processing resources than a command set including coordination between multiple characters with complex dialogue exchanges and environmental interactions.

In operation 706, the system receives, from the AI model, a narrative or narrative segment of the toy using the details provided in the prompt. For example, if the prompt asked the AI model to tell a story about a tennis ball from the perspective of a thrill-seeking superhero, the received narrative describes the tennis ball being used in a fight to defeat the villains relevant to the particular superhero. The AI model maintains a record of a given session which allows the AI model to adapt to various input scenarios to ensure that the narratives are new and relevant. In some embodiments, the reply is non-deterministic, which leads to improved engagement and enjoyment. In embodiments where a deterministic reply is desired, the AI model generates narratives in a non-random manner by vectorizing the reply generated by the AI model and storing the vectorized responses in vector space. For example, the prompt and the associated reply are broken down into vector representations of the alphanumeric characters. Once the prompt and the reply are vectorized, the system extracts the semantic meaning of each vector and understand the vector's context within the sentence and document. For example, word embedding models (e.g., Word2Vec, GloVe) are used to capture the semantic relationships between words and phrases. The models maps words to high-dimensional vector representations, where similar words are closer together in vector space.

The vector representations of the prompt are compared with future prompts. The system aligns the vector representations of the tokens in the incoming prompt with those of the stored prompts. The system identifies similarities and differences between the two sets of vector representations, highlighting areas where the incoming prompt diverges from the stored prompts. Similarity metrics, such as cosine similarity or Jaccard similarity, is used to quantify the similarity between the incoming prompt and the stored prompts. For example, cosine similarity measures the cosine of the angle between two vector representations in vector space, whereas Jaccard similarity measures the similarity between sets of tokens (e.g., the set of tokens of the stored prompts, and the set of tokens of the incoming prompt) by comparing the intersection and union of the tokens within each set and quantify the degree of overlap or similarity between the sets based on their shared vocabulary. The similarity metrics provide numerical measures of how closely any of the stored prompts align with the incoming prompt. If the similarities are above a certain threshold, the system uses the corresponding stored reply for the stored prompt as the reply for the incoming prompt.

In some embodiments, the AI model is locally stored on the toy. By running models directly on the toy, there is improved privacy, reduced latency, and decreased reliance on external servers. With on-device processing, user interactions and personal data remain within the confines of the user's device, reducing the risk of unauthorized access or data breaches. Additionally, local models eliminate the need for constant communication with remote servers, resulting in reduced latency and faster response times. Further, unlike cloud-based models that incur token costs for each inference, local execution eliminates the need for token consumption, offering a cost-effective solution for both users and platform operators.

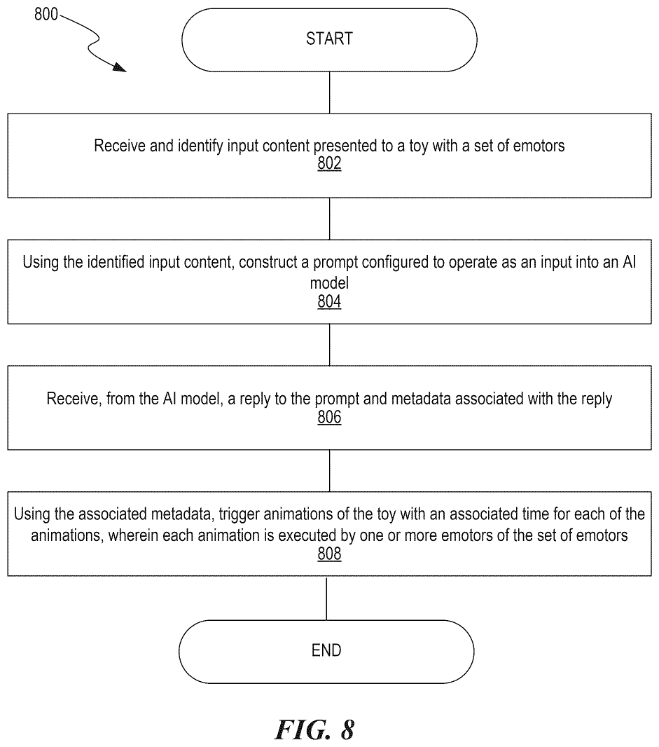

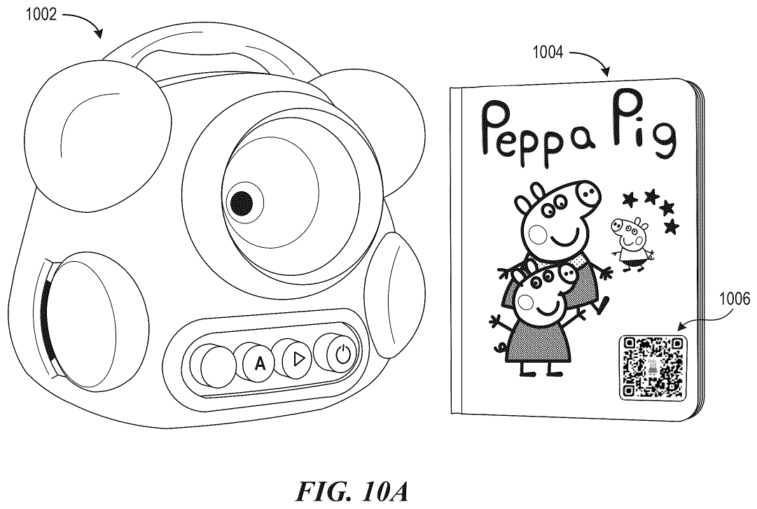

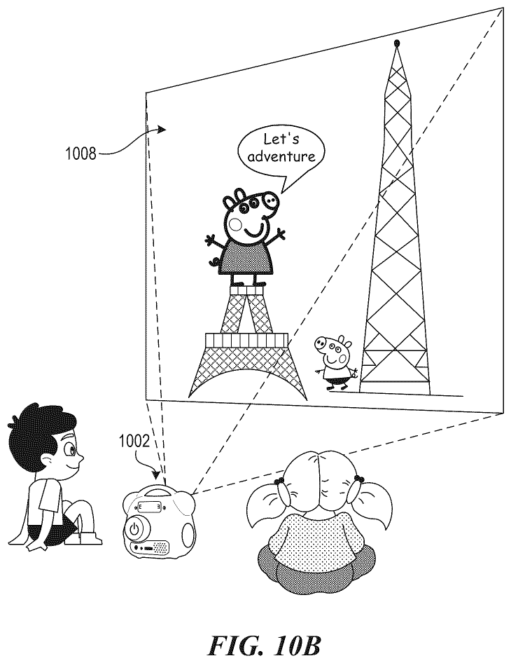

In operation 708, the system presents, via the toy, the narrative or narrative segment from the AI model. The system transmits the narrative or narrative segment via one or more output devices associated with the computing device, such as a speaker (e.g., with a voice profile of the synthetic user/virtual character role applied), a display screen, and/or a projector (such as the synchronized visual and audio representation in FIGS. 10A and 10B). The narrative is presented through modes such as a graphical user interface (GUI), audio files, text, and motorized animations. For example, the GUI features graphical elements such as animated graphics, character portraits, or scene transitions to represent the AI-generated narrative. Audio files are through, in some embodiments, the toy using built-in speakers or other audio output capabilities to deliver spoken dialogue, sound effects, and/or background music corresponding to the AI-generated narrative. In some embodiments, the narrative is presented through text, where dialogue subtitles, narrative descriptions, or interactive prompts are presented on a user interface (e.g., a GUI). Methods of using motorized animations to represent one or more portions of the AI-generated narrative are discussed with reference to FIG. 8.

When the system detects a physical modification in the storytelling environment, such as a change in physical attributes of the objects present in the storytelling environment or a change in the spatial relationships between the objects, the system dynamically updates the command set based on the physical modification. Subsequently, the system generates, using the AI model, a subsequent narrative segment responsive to the updated command set. The subsequent narrative, in some embodiments, indicates the physical modification.

In some embodiments, the system receives, from the user, a selection of a narrative choice point responsive to the initial narrative segment. The narrative choice points are presented, in some embodiments, through visual prompts displayed on a screen associated with the storytelling environment, audio through speakers integrated within the stage, and so forth. The user selection is captured through, for example, touch-based selection on a display interface, voice commands spoken into a microphone coupled to the toy, or physical manipulation of figurines to indicate preferred story directions (as discussed further below with reference to FIG. 9). Responsive to receiving the selection, the system dynamically updates the command set based on the physical modification, and generates, using the AI model, a subsequent narrative segment responsive to the updated command set. The subsequent narrative segment describes the selected narrative choice point.

FIG. 8 is a flowchart illustrating an example method 800 of synchronizing bucketized animations with the synthetic user's responses of an interactive toy. In some implementations, the method 800 is performed by components of example computer system 1100 illustrated and described in more detail with reference to FIG. 11. Likewise, implementations can include different and/or additional operations or can perform the operations in different orders.

In operation 802, the system receives and identifies input content presented to a toy with a set of emotors (e.g., motors, lights), wherein each emotor of the set of emotors is associated with a corresponding expressive output such as a light or a movement path defining a range of motion for one or more segments of the toy. Examples of input content are discussed with reference to FIG. 7. The toy is equipped with emotors that control different parts of the toy's face and/or body in accordance with the bucketized animations. For instance, emotors are enabled to control movements such as eyebrow raises, eye blinks, mouth movements, head tilts/rotations, facial expressions, or limb gestures, allowing characters to convey emotions, interact with objects, or engage in dialogue.

A motor is a mechanical device able to produce motion or movement in specific parts of the toy's structure, such as the toy's face or body. The motors are electrically powered components capable of generating movements based on received input signals from the toy. Each motor is associated with a designated movement path, which delineates the trajectory or pattern of motion that the corresponding part of the toy will follow when the motor is activated. Movement paths of each motor define the range of motion and the sequence of actions that can be executed by the corresponding motor, allowing for a variety of expressions, gestures, and interactions to be conveyed.

In operation 804, using the identified input content, the system constructs a prompt configured to operate as an input into an AI model (e.g., LLM) that includes instructions to generate a narrative or narrative segment for the toy that is responsive to the input content. Examples of prompts and methods of constructing the prompts are discussed with reference to FIG. 7.

In operation 806, the system receives, from the AI model, a reply to the prompt (e.g., the narrative) and metadata associated with the reply. In some embodiments, the AI model outputs the AI model's response in a structured format, such as a JSON object. The JSON output includes not only the dialogue or narrative content but also metadata that is used to enhance the interaction (e.g., by providing structured information that indicates the associated physical movements). Methods of constructing responses of a synthetic user are discussed with reference to FIGS. 5 and 6.

For example, the AI model's reply includes fields for the text response, emotional tone, timing, and suggested animations. The text response field in the example includes content such as the actual narrative/response, while the emotional tone field indicates the emotional state (e.g., happy, sad, excited) that is reflected in the character's voice and facial expressions. The timing field in the JSON output specifies the duration for which the dialogue is spoken. The timing field is used, in some embodiments, to synchronize the animations and motorized/light actions of the toy. By identifying the length of the spoken dialogue, the system ensures that movements, such as lip-syncing and head gestures, are timed to match the audio. Additionally, the suggested animations field provides content such as recommendations for specific animations or movements that align with the dialogue and emotional tone. For example, a joyful response that contains a 10-second audio file is paired with animations that include three animations that loop every 0.8 seconds (e.g., smiling and enthusiastic hand gestures), while a 10-second solemn response triggers a single slower, more subdued movement that is looped every 5 seconds.

The system parses the narrative and metadata from the AI model and maps each field to corresponding actions and animations. The metadata includes instructions to categorize one or more portions of the narrative into a particular animation (or animation sequence) of a set of predefined different animations (or animation sequences). The categorization is performed, for example, based on a common keyword, emotion, and so forth indicated by the portion of the narrative and the particular animation. For example, the system parses the JSON to extract the text response, which is then converted into speech using a text-to-speech engine. The emotional tone field guides the modulation of the synthetic voice to convey the appropriate emotion. Meanwhile, the timing data ensures that the animations are synchronized with the speech. The system maps the animations to one or more physical emoters enabled to control respective segments of the toy in accordance with the particular animation. The suggested animations are then matched with pre-defined animation sequences stored in a database, and the relevant emotor commands are executed on the toy along with the output of the text-to-speech engine.

In operation 808, using the associated metadata, the system triggers particular bucketized animations of the toy with an associated time for each of the bucketized animations, where each bucketized animation is associated with (e.g., executed by) one or more motors of the set of emotors of the toy. Bucketized animations refer to pre-defined sets of motorized/light animations categorized based on different narrative contexts and character actions. Each bucket includes animations such as walking, fighting, talking, or expressing emotions like joy or anger. Bucketized animations range from simple animations, such as basic movements such as opening the mouth to be used to simulate speech, or small, repetitive head movements to indicate agreement or add emphasis to the spoken words, to more complex movements such as a combination of facial expressions and body movements (e.g., raising eyebrows, widening eyes, and moving the head or hands) to convey particular expressions/emotions.

When the system receives the output from the AI model (e.g., such as a JSON object), the system parses the JSON object to extract the relevant fields. The system uses the metadata to align the dialogue with emotorized reactions and animations. Using the metadata associated with the length of the dialogue, the system synchronizes the start and end of the dialogue with the corresponding animations. For example, if the length is 3000 milliseconds, the animation should match the duration. Triggering the suggested animation from the metadata. For example, if the suggested animation is “wave,” the system will execute the pre-defined wave animation sequence.

When constructing the prompt for the AI model, the system, in some embodiments, pre-loads query context about the relevant bucketized animations. For example, if the narrative involves an exciting story, the pre-loaded query context includes a bucketized animation tag indicating excitement animations. Pre-loading query context into the AI model helps the AI model determine not only the narrative context, but also the expected physical actions that correspond with the AI model's output.

In some embodiments, instead of pre-loading query context containing indicators of specific animations, the system pre-loads a bucketized animation table into the AI model. The bucketized animation table includes various categories of animations that the AI selects based on the narrative context. The AI model, upon receiving the prompt and the animation table, evaluates the context of the narrative and characterizes the sentiment of the narrative, such as identifying if the tone is joking, serious, or excited. The AI model provides the sentiment to the toy, and the toy interprets the sentiment to trigger the appropriate pre-programmed animations, ensuring that the physical actions of the toy align with the emotional tone of the generated dialogue. For example, when the AI determines that the output sentiment is joking, the toy associates the “joking” sentiment with a specific animation (e.g., via a predefined association that is reflected in the metadata output of the AI and employed as instructions by the toy), such as a particular animation that is a head wobble that takes 0.8 seconds to loop. In some embodiments, the sentiment triggers multiple animations. For example, in addition the head wobble animation that takes 0.8 seconds to loop, the “joking” sentiment also triggers a one-time animation that is a head tilt that takes 0.5 seconds to complete. The AI model tailors the AI model's selection of the animation to the evolving narrative, ensuring that the physical actions of the figurines remain relevant and engaging throughout the storytelling process.

To animate the toy, the toy includes emotors to control different facial expressions or other animatronic movements. For example, emotors are used to animate various facial features such as the eyebrows, eyes, and mouth. An eyebrow emotor is dedicated to controlling the movement of the eyebrows. By adjusting the angle and position, the system conveys emotions such as surprise, anger, or curiosity. An eye emotor manages the movement of the eyes, enabling expressions like blinking, widening in surprise, or narrowing in suspicion. A mouth emotor synchronizes mouth movements with spoken dialogue, creating a realistic lip-sync effect.

In some embodiments, functional motors and/or dynamic motors are used. Functional motors are primarily used for practical purposes such as talking. They are synchronized with the AI-generated dialogue to ensure lip-sync accuracy. For instance, as the AI character speaks, the motor controlling the mouth moves in tandem with the speech patterns, providing a natural talking effect. On the other hand, dynamic motors handle expressive movements that convey emotions. Based on the metadata received from the AI output, such as emotional tone or keywords, the dynamic motors adjust the facial features accordingly. For example, if the AI indicates that the speech of the character is “excited” for 2.4 seconds, the toy makes use of that output metadata by triggering a bucketized set of pre-configured motor instructions corresponding to “excited” to raise the eyebrows and widen the eyes for the corresponding 2.4 seconds. As the audio file is played by the toy, the audio metadata is synchronized with the audio emission to provide animatronic motor instructions lined up with the audio. The bucketized animations are enabled to be presented by triggering the one or more motors to cause a movement of respective segments of the toy for the particular time period. The toy presents each animation by triggering the one or more physical emoters for a duration of a respective portion of the narrative.

Bucketized animations include, in some embodiments, predefined sets of motor movements associated with specific keywords (e.g., emotions) extracted from the AI's output. Keywords such as “snarky,” “surprised,” or “excited” are identified from the AI's response. These keywords guide the selection of appropriate facial animations. Each keyword is linked to a set of pre-recorded motor sequences on the toy. For example, a “snarky” expression involves raising one eyebrow slightly and turning the corners of the mouth upward. In another example, if the AI response includes the keyword “surprised,” the system will execute the pre-recorded motor sequence for a surprised expression, involving raised eyebrows and widened eyes.

Along with the animations, in some embodiments, the toy audibly presents the reply in a synchronized manner with the animations (e.g., concurrently) through a speaker coupled to the toy. For example, AI voice cloning models are used to generate a voice for the toy (e.g., a luxurious voice for a plate of caviar, Peppa Pig's voice, or other synthetic voice). In some embodiments, the AI voice cloning model(s) are trained on datasets of human speech samples, allowing the models to learn the nuances of vocal characteristics, intonations, and speech patterns. In some embodiments, the toys are assigned voices along a human voice bell curve, which encompasses a range of vocal characteristics commonly found within the human population, including variations in pitch, tone, accent, and speech rate.

In some embodiments, the system tracks previous responses and corresponding bucketized animations and identifies one or more patterns associated with historical user interactions with the toy using the tracked previous responses and corresponding bucketized animations. The system adjusts subsequent prompts based on the identified one or more patterns. For example, the system determines (e.g., via another AI model or rule-based system) that a user consistently engages for longer periods when narratives include mystery-solving elements. Based on the identified patterns, the system dynamically adjusts subsequent prompt construction to incorporate elements that align with the user's demonstrated preferences. The system pre-loads query context into the AI model to assign greater weight to certain narrative themes, pre-load character personality traits that have previously resulted in positive user engagement, or modify the complexity level of generated content based on the user's historical interaction patterns.

### Interactive Playset Environments Using AI-Driven Narrative Generation

FIG. 9 is a diagram illustrating an example interactive playset environment 900 using AI-driven narrative generation. Playset environment 900 (e.g., diorama, scene, game platform) includes sculpture 902 and identifier 904 in character figurines 906, stage 908, and object figurine 910. In some embodiments, implementations of example interactive playset environment 900 include different and/or additional components or are connected in different ways.

Sculpture 902 and identifier 904 together form the character figurine 906, where the sculpture 902 and/or the identifier 904 enable the system to recognize and differentiate the figurine as a unique character within the interactive playset environment. In some embodiments, the identifier 904 is an NFC tag with a unique ID, which the stage 908 reads and processes. The identifier 904 allows the stage 908 to access specific data associated with the character figurine 906, such as predefined attributes, personality, behaviors, and/or backstory elements. Sculpture 902 provides the physical representation of the character, which is able to be customized with different outfits, accessories, and expressions to improve the storytelling experience and represent the intended character. When the character figurine 906 is placed on the stage, the 906AI model generates narrative content that incorporates the character figurine 906 into a coherent narrative.

In some examples, playset environment 900 is a card game platform (e.g., DropMix), where the sculpture 902 is a card, the identifier 904 is the card's embedded NFC tags, and the stage 908 is a board. The card's embedded NFC tag corresponds to a particular audio clip, such as a drum loop or a vocal selection. With multiple NFC-embedded cards on the board, the system creates a “mashup,” or an audio file that incorporates all of the corresponding audio clips of the cards placed on the board.

In some embodiments, object figurine 910 includes a similar identifier 904, which allows the stage 908 to recognize and classify the object figurine 910 as an object rather than a character. The object figurine 910 represents a wide range of items/objects, such as buildings, vehicles, tools, environmental objects (e.g., rocks), or abstract elements such as magical artifacts. The identifier 904 on an object figurine 910 ensures that the AI model is able to access relevant data about the object's properties and potential roles in the narrative. For instance, a castle object figurine triggers storylines involving quests, battles, or royal events when identified by the stage 908. By differentiating between character figurines 906 and object figurines 910 (based on the ID assigned each by a corresponding NFC chip), the system generates more nuanced and contextually appropriate narratives, improving the overall storytelling experience.

Stage 908 in the interactive playset environment 900 includes a localized AI model or connects to a cloud-based model via a wireless transceiver. Stage 908 is able to identify multiple identifiers 904 simultaneously. In a localized setup, the AI model is embedded directly within the stage's hardware, allowing for immediate, real-time processing of inputs without the need for an internet connection, though with a less robust training set. A localized setup ensures low-latency responses and increases the playset's portability, as users are able to enjoy dynamic storytelling even in offline scenarios. Alternatively, a cloud-based model accessed through a wireless transceiver, which facilitates the communication between the stage and the cloud, enables the stage to leverage more computational resources and up-to-date AI algorithms, and thus supports more complex and extensive narrative generation.

In addition to or alternatively to the NFC tags, some embodiments of the interactive playset environment 900 use a camera system to recognize and differentiate between various figurines. Users take photos of new or existing figurines and objects, and the AI model analyzes the images to determine their identity and potential role in the story. For example, if a user introduces a new figurine by taking a photo, the AI recognizes the new figurine's features and categorize the new figurine as a specific character figurine 906 or object figurine 910. The camera captures images of the character figurine 906 and object figurine 910 placed on the stage 908, which are sent to an AI model, such as GPT, to perform facial recognition and/or object recognition to identify the elements within the playset environment 900. Facial recognition enables the identification of character figurines based on their facial features. Object recognition allows the system to identify various objects within the playset, assigning them appropriate roles and attributes within the narrative.

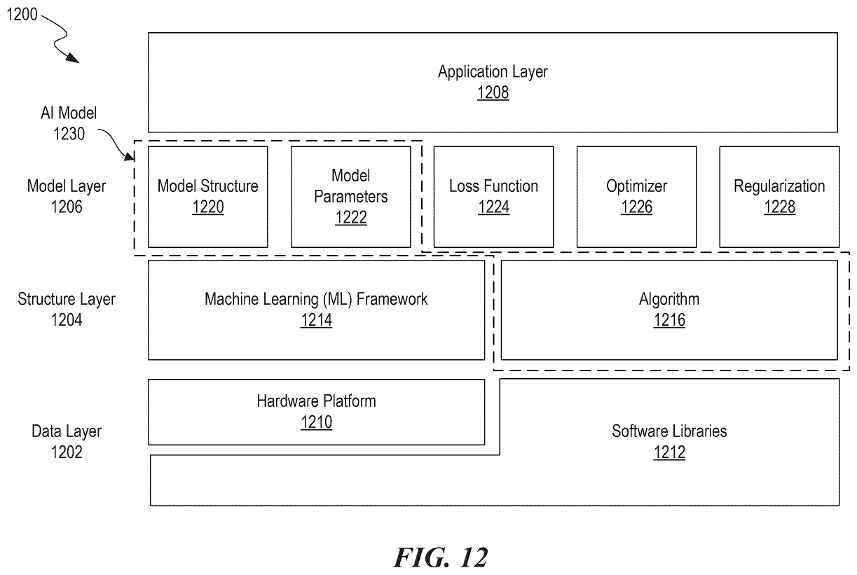

The AI model generates storylines (e.g., narratives) based on the recognized character figurines 906 and/or object figurines 910, incorporating them into the narrative in contextually appropriate ways. For example, if the system identifies a figurine of a superhero, the AI model introduces plotlines that involve heroic actions, conflicts, and resolutions centered around that character. Methods of generating narratives are further described with reference to FIGS. 5-7. Examples of AI models are discussed with reference to FIG. 12. Rather than triggering pre-recorded audio associated with a corresponding character figurine 906, a command set is generated ad hoc by the system to dynamically populating a predefined template with real-time information identified from the character figurines 906 and/or object figurines 910 present on the stage. When a figurine is recognized, for example, through an NFC tag or image recognition, the system employs relevant attributes associated with the NFC tag or image, such as the character type, setting, and mood. The attributes are used to fill in the blanks of a command set template. The ad hoc generation ensures that each command set is tailored to the specific character figurines 906 and/or object figurines 910 detected, allowing for spontaneous and contextually appropriate storytelling.

In some embodiments, to generate the narratives, the system creates synthetic users from the character figurines 906 and the object figurines 910 and gives the character figurines 906 and the object figurines 910 improvisation scenarios. The synthetic users are able to engage in back-and-forth interactions with the user and/or other figurines on the stage 908.

For example, a template command set (e.g., prompt) to the AI model is “You are ______, tell me a story about ______, you are telling this in ______, your tone should be ______.” The system then populates the template using information identified from the character figurines 906 and the object figurines 910. For example, the populated command set to the AI model is “You are a wizard, tell me a story about a castle, you are telling this in a mystical forest, your tone should be excited.” The populated command set guides the AI to generate dialogue and actions of the character figurines 906 and/or the object figurines 910 that are characteristic of the respective identified attributes of the corresponding synthetic users. For example, the “wizard” is filled in based on an NFC tag identifying a particular character figurine as a wizard, and the “castle” is filled in based on an NFC tag identifying a particular object figurine as a castle, which ensures that the generated narrative aligns with the physical figurine placed on the stage.

When the stage 908 detects multiple character figurines 906 and/or object figurines 910 present, the command set is expanded to accommodate the increased complexity and potential interactions between the character figurines 906 and the object figurines 910. The expanded command set includes, for example, additional narrative possibilities by including additional template options that are populated with the added character figurines 906 or object figurines 910. For example, the AI model generates dialogue where character figurines already on stage 908 engage in new conversations, collaborate on tasks, or participate in conflict scenarios with the added character figurines. By recognizing the presence of multiple character figurines 906 and/or object figurines 910, the stage broadens the narrative scope, creating a more engaging environment for the user.

In some embodiments, conversations between the character figurines 906 and/or the object figurines 910 are recorded and used as subsequent inputs in the AI model to generate new replies using improvisation techniques (e.g., a “yes, and?” approach) to build on the dialogue and actions presented. For example, a reply of the AI model that indicates the dialogue for a particular character figurine is included in a subsequent prompt of the AI model, such as a prompt stating, “Character 1 just said ______. How would Character 2 reply?” The iterative process allows the AI to generate the next part of the storyline based on the ongoing interactions, ensuring that the narrative remains engaging and coherent.

In some embodiments, the system uses a pre-defined decision tree to guide the storyline. A pre-defined decision tree provides a structured framework where specific user inputs trigger predetermined narrative branches. The method ensures that the story progresses in a coherent and well-planned manner with a controlled environment for storytelling. Each node in the decision tree represents a narrative event or choice point (e.g., two characters deciding to collaborate, one character winning a fight), and the paths branching out from each node lead to different outcomes based on user selections.

The system allows for a variety of input methods to modify the command set and drive the interactive storytelling experience. By using different types of inputs, users engage with the narrative in a more immersive and personalized way. For example, input methods include figurines (the character figurines 906, the object figurines 910), microphone input, buttons, and/or the physical location of items on the stage. Microphone input allows users to interact with the system using voice commands or dialogue. For example, a user voices a command to their favorite character, prompting the system to generate a real-time response and adjust the storyline accordingly. In some embodiments, voice/audio inputs are used to make choices in the narrative, ask questions, or provide additional details that increase the depth and personalization of the story. Additionally, users are able to press buttons to make selections, initiate actions, or modify the story flow. In some embodiments, a button on the playset environment (e.g., on the stage 908) is used to choose between different story paths, activate specific character actions, or trigger special effects. Buttons are able to be designed to represent different actions or choices within the narrative, making it easy for users to navigate and influence the story.

The physical location and height of figurines on the stage also modify the command set. The system detects where on the stage a figurine is placed (via multiple NFC readers) and at what height (via positional sensors in the in the stage 908), using the spatial information to influence the narrative. For example, placing a character figurine on a high platform might signify a vantage point, leading to a scenario where the character has a strategic advantage. The AI model returns, in some embodiments, a generated narrative that references the identified spatial information, such as “I now have the high ground!” Additionally, placing a figurine close to an object might trigger an interaction between the character and the object, such as picking up a tool or engaging in a battle. In another example, placing a hero figurine next to a villain figurine triggers a storyline involving a confrontation, depending on their relative positions and identified roles. The spatial awareness allows for a more nuanced and interactive storytelling experience, where the physical arrangement of figurines directly impacts the unfolding narrative.

Users are able to introduce new characters, objects, or settings and observe how the AI adapts the story to incorporate these elements. The interactivity of the playset environment not only increases user engagement but also encourages exploration and experimentation, as users discover the possibilities of storytelling using AI-driven narratives.

The AI model generates narratives based on variable inputs, ensuring that each storytelling session is dynamic and unpredictable. The generated narrative or narrative segments describes the objects in accordance with the physical attributes of the objects and/or the spatial relationships between the objects. Even if the position of the character figurines 906 and object figurines 910 remain the same, the generated narratives include subtle variations in language, tone, and plot elements, and ensures that each iteration of the story is unique. Users are able to revisit the same scenario multiple times, and still encounter new and compelling narrative outcomes.

FIG. 10A is a diagram illustrating an example interactive device (e.g., interactive toy 1002) that uses AI-driven narrative generation. In some embodiments, the interactive toy 1002 is associated with an external or supplementary object, such as book 1004. The interactive toy 1002 includes a housing and has one or more presentation elements (e.g., play/stop buttons, speakers, display screens, projector, and so forth) coupled to or otherwise associated with the housing structure. In FIG. 10A, the book 1004 is a storybook indicating virtual character role(s) associated with the interactive toy 1002 (e.g., “Peppa Pig” characters) and associated textual content. The book 1004 includes an identifier, such as QR code 1006 positioned on the cover surface. The QR code 1006 includes a machine-readable pattern that provides identification data corresponding to specific content associated with the book 1004. In some embodiments, the interactive toy 1002 scans the QR code 1006 to initiate corresponding interactive content generation.

FIG. 10B is a diagram illustrating the presentation of the generated narrative by projecting a display using the interactive toy 1002 of FIG. 10A. In particular, FIG. 10B illustrates the interactive toy 1002 in an operational state where the interactive toy 1002 functions as a projection apparatus. The interactive toy 1002 projects visual content onto a projection screen 1008, thus creating a display surface for presenting narrative content. The projected content includes visual displays (e.g., animated imagery) indicative of the virtual character role(s) (e.g., “Peppa Pig” cartoon characters). The projection system transforms static book 1004 content into dynamic visual presentations through the output devices (e.g., the projector) of the interactive toy 1002.

### Computing Platform

FIG. 11 is a block diagram illustrating an example computer system 1100, in accordance with one or more embodiments. In some embodiments, components of the example computer system 1100 are used to implement the software platforms described herein. At least some operations described herein can be implemented on the computer system 1100.

In some embodiments, the computer system 1100 includes one or more central processing units (“processors”) 1102, main memory 1106, non-volatile memory 1110, network adapters 1112 (e.g., network interface), video displays 1118, input/output devices 1120, control devices 1122 (e.g., keyboard and pointing devices), drive units 1124 including a storage medium 1126, and a signal generation device 1120 that are communicatively connected to a bus 1116. The bus 1116 is illustrated as an abstraction that represents one or more physical buses and/or point-to-point connections that are connected by appropriate bridges, adapters, or controllers. The bus 1116, therefore, includes a system bus, a peripheral component interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1194 bus (also referred to as “Firewire”).

In some embodiments, the computer system 1100 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1100.

While the main memory 1106, non-volatile memory 1110, and storage medium 1126 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 1128. The term “machine-readable medium” and “storage medium” shall also be taken to include any medium that is capable of storing, encoding, or carrying a set of instructions for execution by the computer system 1100. In some embodiments, the non-volatile memory 1110 or the storage medium 1126 is a non-transitory, computer-readable storage medium storing computer instructions, which is executable by the one or more “processors” 1102 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 1104, 1108, 1128) set at various times in various memory and storage devices in a computer device. When read and executed by the one or more processors 1102, the instruction(s) cause the computer system 1100 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually affect the distribution.

Further examples of machine-readable storage media, machine-readable media, or computer-readable media include recordable-type media such as volatile and non-volatile memory 1110 devices, floppy and other removable disks, hard disk drives, optical discs (e.g., compact disc read-only memory (CD-ROMS), digital versatile discs (DVDs)), and transmission-type media such as digital and analog communication links.

The network adapter 1112 enables the computer system 1100 to mediate data in a network 1114 with an entity that is external to the computer system 1100 through any communication protocol supported by the computer system 1100 and the external entity. The network adapter 1112 includes a network adapter card, a wireless network interface card, a router, an access point, a wireless router, a switch, a multilayer switch, a protocol converter, a gateway, a bridge, a bridge router, a hub, a digital media receiver, and/or a repeater.

In some embodiments, the network adapter 1112 includes a firewall that governs and/or manages permission to access proxy data in a computer network and tracks varying levels of trust between different machines and/or applications. The firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). In some embodiments, the firewall additionally manages and/or has access to an access control list that details permissions, including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example ML system 1200 illustrated and described in more detail with reference to FIG. 12.

### AI System

FIG. 12 is a high-level block diagram illustrating an example AI system, in accordance with one or more embodiments. The AI system 1200 is implemented using components of the example computer system 1100 illustrated and described in more detail with reference to FIG. 11. Likewise, embodiments of the AI system 1200 include different and/or additional components or be connected in different ways.

In some embodiments, as shown in FIG. 12, the AI system 1200 includes a set of layers, which conceptually organize elements within an example network topology for the AI system's architecture to implement a particular AI model 1230. Generally, an AI model 1230 is a computer-executable program implemented by the AI system 1200 that analyses data to make predictions. Information passes through each layer of the AI system 1200 to generate outputs for the AI model 1230. The layers include a data layer 1202, a structure layer 1204, a model layer 1206, and an application layer 1208. The algorithm 1216 of the structure layer 1204 and the model structure 1220 and model parameters 1222 of the model layer 1206 together form the example AI model 1230. The optimizer 1226, loss function engine 1224, and regularization engine 1228 work to refine and optimize the AI model 1230, and the data layer 1202 provides resources and support for the application of the AI model 1230 by the application layer 1208.

The data layer 1202 acts as the foundation of the AI system 1200 by preparing data for the AI model 1230. As shown, in some embodiments, the data layer 1202 includes two sub-layers: a hardware platform 1210 and one or more software libraries 1212. The hardware platform 1210 is designed to perform operations for the AI model 1230 and includes computing resources for storage, memory, logic, and networking, such as the resources described in relation to FIGS. 3A and 3B. The hardware platform 1210 processes amounts of data using one or more servers. The servers can perform backend operations such as matrix calculations, parallel calculations, machine learning (ML) training, and the like. Examples of servers used by the hardware platform 1210 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 1210 includes Infrastructure as a Service (IaaS) resources, which are computing resources, (e.g., servers, memory, etc.) offered by a cloud services provider. In some embodiments, the hardware platform 1210 includes computer memory for storing data about the AI model 1230, application of the AI model 1230, and training data for the AI model 1230. In some embodiments, the computer memory is a form of random-access memory (RAM), such as dynamic RAM, static RAM, and non-volatile RAM.

In some embodiments, the software libraries 1212 are thought of as suites of data and programming code, including executables, used to control the computing resources of the hardware platform 1210. In some embodiments, the programming code includes low-level primitives (e.g., fundamental language elements) that form the foundation of one or more low-level programming languages, such that servers of the hardware platform 1210 can use the low-level primitives to carry out specific operations. The low-level programming languages do not require much, if any, abstraction from a computing resource's instruction set architecture, allowing them to run quickly with a small memory footprint. Examples of software libraries 1212 that can be included in the AI system 1200 include Intel Math Kernel Library, Nvidia cuDNN, Eigen, and Open BLAS.

In some embodiments, the structure layer 1204 includes an ML framework 1214 and an algorithm 1216. The ML framework 1214 can be thought of as an interface, library, or tool that allows users to build and deploy the AI model 1280. In some embodiments, the ML framework 1214 includes an open-source library, an application programming interface (API), a gradient-boosting library, an ensemble method, and/or a deep learning toolkit that works with the layers of the AI system facilitate development of the AI model 1230. For example, the ML framework 1214 distributes processes for the application or training of the AI model 1230 across multiple resources in the hardware platform 1210. In some embodiments, the ML framework 1214 also includes a set of pre-built components that have the functionality to implement and train the AI model 1230 and allow users to use pre-built functions and classes to construct and train the AI model 1230. Thus, the ML framework 1214 can be used to facilitate data engineering, development, hyperparameter tuning, testing, and training for the AI model 1230. Examples of ML frameworks 1214 that can be used in the AI system 1200 include TensorFlow, PyTorch, Scikit-Learn, Keras, Caffe, LightGBM, Random Forest, and Amazon Web Services.

In some embodiments, the algorithm 1216 is an organized set of computer-executable operations used to generate output data from a set of input data and can be described using pseudocode. In some embodiments, the algorithm 1216 includes complex code that allows the computing resources to learn from new input data and create new/modified outputs based on what was learned. In some implementations, the algorithm 1216 builds the AI model 1230 through being trained while running computing resources of the hardware platform 1210. The training allows the algorithm 1216 to make predictions or decisions without being explicitly programmed to do so. Once trained, the algorithm 1216 runs at the computing resources as part of the AI model 1230 to make predictions or decisions, improve computing resource performance, or perform tasks. The algorithm 1216 is trained using supervised learning, unsupervised learning, semi-supervised learning, and/or reinforcement learning.

The application layer 1208 describes how the AI system 1200 is used to solve problems or perform tasks. In an example implementation, the application layer 1208 includes the response generator 314.

As an example, to train an AI model 1230 that is intended to model human language (also referred to as a language model), the data layer 1202 is a collection of text documents, referred to as a text corpus (or simply referred to as a corpus). The corpus represents a language domain (e.g., a single language), a subject domain (e.g., scientific papers), and/or encompasses another domain or domains, be they larger or smaller than a single language or subject domain. For example, a relatively large, multilingual, and non-subject-specific corpus is created by extracting text from online web pages and/or publicly available social media posts. In some embodiments, data layer 1202 is annotated with ground truth labels (e.g., each data entry in the training dataset is paired with a label), or unlabeled.

Training an AI model 1230 generally involves inputting into an AI model 1230 (e.g., an untrained ML model) data layer 1202 to be processed by the AI model 1230, processing the data layer 1202 using the AI model 1230, collecting the output generated by the AI model 1230 (e.g., based on the inputted training data), and comparing the output to a desired set of target values. If the data layer 1202 is labeled, the desired target values, in some embodiments, are, e.g., the ground truth labels of the data layer 1202. If the data layer 1202 is unlabeled, the desired target value is, in some embodiments, a reconstructed (or otherwise processed) version of the corresponding AI model 1230 input (e.g., in the case of an autoencoder), or is a measure of some target observable effect on the environment (e.g., in the case of a reinforcement learning agent). The parameters of the AI model 1230 are updated based on a difference between the generated output value and the desired target value. For example, if the value outputted by the AI model 1230 is excessively high, the parameters are adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the AI model 1230 typically is to minimize a loss function or maximize a reward function.

In some embodiments, the data layer 1202 is a subset of a larger data set. For example, a data set is split into three mutually exclusive subsets: a training set, a validation (or cross-validation) set, and a testing set. The three subsets of data, in some embodiments, are used sequentially during AI model 1230 training. For example, the training set is first used to train one or more ML models, each AI model 1230, e.g., having a particular architecture, having a particular training procedure, being describable by a set of model hyperparameters, and/or otherwise being varied from the other of the one or more ML models. The validation (or cross-validation) set, in some embodiments, is then used as input data into the trained ML models to, e.g., measure the performance of the trained ML models and/or compare performance between them. In some embodiments, where hyperparameters are used, a new set of hyperparameters is determined based on the measured performance of one or more of the trained ML models, and the first step of training (i.e., with the training set) begins again on a different ML model described by the new set of determined hyperparameters. These steps are repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) begins in some embodiments. The output generated from the testing set, in some embodiments, is compared with the corresponding desired target values to give a final assessment of the trained ML model's accuracy. Other segmentations of the larger data set and/or schemes for using the segments for training one or more ML models are possible.

Backpropagation is an algorithm for training an AI model 1230. Backpropagation is used to adjust (also referred to as update) the value of the parameters in the AI model 1230, with the goal of optimizing the objective function. For example, a defined loss function is calculated by forward propagation of an input to obtain an output of the AI model 1230 and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. In some embodiments, other techniques for learning the parameters of the AI model 1230 are used. The process of updating (or learning) the parameters over many iterations is referred to as training. In some embodiments, training is carried out iteratively until a convergence condition is met (e.g., a predefined maximum is number of iterations has been performed, or the value outputted by the AI model 1230 sufficiently converged with the desired target value), after which the AI model 1230 is considered to be sufficiently trained. The values of the learned parameters are then fixed and the AI model 1230 is then deployed to generate output in real-world applications (also referred to as “inference”).

In some examples, a trained ML model is fine-tuned, meaning that the values of the learned parameters are adjusted slightly in order for the ML model to better model a specific task. Fine-tuning of an AI model 1230 typically involves further training the ML model on a number of data samples (which may be smaller in number/cardinality than those used to train the model initially) that closely target the specific task. For example, an AI model 1230 for generating natural language that has been trained generically on publicly available text corpora is, e.g., fine-tuned by further training using specific training samples. In some embodiments, the specific training samples are used to generate language in a certain style or a certain format. For example, the AI model 1230 is trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

In some embodiments, the language model uses a neural network (typically a DNN) to perform NLP tasks. A language model is trained to model how words relate to each other in a textual sequence, based on probabilities. In some embodiments, the language model contains hundreds of thousands of learned parameters, or in the case of a large language model (LLM) contains millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

Although a general transformer architecture for a language model and the model's theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that is considered to be an encoder-only language model. A decoder-only language model accepts embeddings as input and uses auto-regression to generate an output text sequence. Transformer-XL and GPT-type models are language models that are considered to be decoder-only language models.

Because GPT-type language models tend to have a large number of parameters, these language models are considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that GPT-3 can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model is hosted by a computer system that includes a plurality of cooperating (e.g., cooperating via a network) computer systems that are in, for example, a distributed arrangement. Notably, a remote language model employs a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real-time or near real-time) can require the use of a plurality of processors/cooperating computing devices as discussed above.

In some embodiments, inputs to an LLM are referred to as a prompt, which is a natural language input that includes instructions to the LLM to generate a desired output. In some embodiments, a computer system generates a prompt that is provided as input to the LLM via the LLM's API. As described above, the prompt is processed or pre-processed into a token sequence prior to being provided as input to the LLM via the LLM's API. A prompt includes one or more examples of the desired output, which provides the LLM with additional information to enable the LLM to generate output according to the desired output. Additionally or alternatively, the examples included in a prompt provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples is referred to as a zero-shot prompt.

In some embodiments, the llama2 is used as a large language model, which is a large language model based on an encoder-decoder architecture, and can simultaneously perform text generation and text understanding. The llama2 selects or trains proper pre-training corpus, pre-training targets and pre-training parameters according to different tasks and fields, and adjusts a large language model on the basis so as to improve the performance of the large language model under a specific scene.

In some embodiments, the Falcon40B is used as a large language model, which is a causal decoder-only model. During training, the model predicts the subsequent tokens with a causal language modeling task. The model applies rotational positional embeddings in the model's transformer model and encodes the absolution positional information of the tokens into a rotation matrix.

In some embodiments, the Claude is used as a large language model, which is an autoregressive model trained on a large text corpus unsupervised.

Consequently, alternative language and synonyms can be used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described but can be practiced with modification and alteration within the spirit and scope of the appended claims. Accordingly, the specification and drawings are to be regarded in an illustrative sense rather than a restrictive sense.

We claim:

1. A computer-implemented method for synchronizing physical animations with AI-driven responses of a physical interactive toy, the method comprising:
receiving input content presented to a toy, wherein the toy includes a set of physical emoters configured to control expressive output of different segments of the toy, wherein the physical emoters include any of motors or lights, and wherein the expressive output comprises any of physical movements or visual displays to emulate one or more of: an emotional state or a narrative context;
constructing a prompt configured to operate as an input into an AI model, wherein the prompt includes instructions to generate a narrative segment for the toy that is responsive to the input content;
receiving, from the AI model, a response to the prompt that includes (a) the narrative segment and (b) metadata comprising instructions to categorize each portion of the narrative segment into a particular animation sequence of a set of predefined different animation sequences based on a common emotion or keyword indicated by the portion of the narrative segment and the particular animation sequence;
mapping each particular animation sequence to one or more physical emoters configured to control respective segments of the toy in accordance with the particular animation sequences; and
presenting, via one or more output devices associated with the toy, the narrative segment and each particular animation sequence,
wherein each particular animation sequence is presented by triggering the one or more physical emoters for a duration of a respective portion of the narrative segment.

2. The computer-implemented method of claim 1, further comprising:
determining a synthetic voice to narrate the response to the prompt; and
presenting the response using the synthetic voice through a speaker coupled to the toy.

3. The computer-implemented method of claim 1, wherein the input content includes image data, and wherein the method further comprises:
identifying one or more objects or characters in proximity to the toy based on the image data; and
defining the identified objects or characters within the prompt, wherein the received response to the prompt describes the identified objects or characters.

4. The computer-implemented method of claim 1, further comprising:
detecting a change in the input content corresponding to a physical modification of the toy or environment associated with the toy;
updating the prompt based on the detected change; and
generating, using the AI model, a subsequent response that indicates the physical modification.

5. The computer-implemented method of claim 1, wherein the AI model is configured to:
determine one or more of: the emotion or the keyword associated with the portion of the narrative segment; and
select the particular animation sequence from a database, wherein the selection is based on the one or more determined emotion or keyword.

6. The computer-implemented method of claim 1, further comprising:
tracking previous responses and corresponding animation sequences;
identifying one or more patterns associated with historical user interactions with the toy using the tracked previous responses and the corresponding animation sequences; and
adjusting subsequent prompts based on the identified one or more patterns.

7. The computer-implemented method of claim 1, wherein the toy includes a display screen, and the method further comprises:
generating visual content corresponding to the response to the prompt;
synchronizing the visual content with the predefined animation sequence; and
displaying the synchronized visual content on the display screen concurrently with the predefined animation sequence.

8. The computer-implemented method of claim 1, wherein presenting the narrative segment and the predefined animation sequence further comprises:
synchronizing a duration of the narrative segment with a duration of the predefined animation sequence by performing one or more of: an adjustment of a playback speed of the predefined animation sequence to match the duration of the narrative segment or a truncation of the predefined animation sequence to align with an end of the narrative segment.

9. The computer-implemented method of claim 1, wherein the predefined animation sequence comprises:
a combination of multiple different predetermined animation components executed in sequence to produce the particular expressive output.

10. The computer-implemented method of claim 1, wherein the prompt includes a description of available predefined animation sequences and timing parameters for each available predefined animation sequence, and wherein the AI model selects the particular animation sequence based on the description and timing parameters.

11. The computer-implemented method of claim 1, wherein the metadata includes an emotional tone identifier for each portion of the narrative segment, and wherein the metadata associates each emotional tone identifier with a respective predefined animation sequence from a database.

12. The computer-implemented method of claim 1, wherein the input content includes one or more of:
NFC data from one or more Near Field Communication (NFC) tags associated with objects positioned on or proximate to the toy,
audio data captured by one or more microphones associated with the toy, or
image data captured by one or more cameras associated with the toy.

13. A computer-implemented method for synchronizing physical animations with AI-driven responses of an animatronic object, the method comprising:
receiving, by a set of sensors coupled to the animatronic object, input content from an environment surrounding the animatronic object;
determining, by a communication interface of the animatronic object, a set of instructions that includes (a) audio data corresponding to a narrative response and (b) metadata comprising instructions to categorize each portion of the audio data into a particular sequence of movements of a set of predefined different sequence of movements based on a common visual attribute indicated by the portion of the audio data and the particular sequence of movements, wherein the set of instructions is generated using an AI model in accordance with the input content;
activating a set of physical emoters within the animatronic object to execute the particular sequence of movements, wherein the set of physical emoters is activated in synchronization with playback of the audio data; and
presenting the audio data through a speaker of the animatronic object and the particular sequence of movements via the animatronic object by moving respective segments of the animatronic object using the activated set of physical emoters for a duration of a respective portion of the audio data.

14. The computer-implemented method of claim 13, wherein the input content includes audio input, and the method further comprises:
identifying a set of verbal commands within the audio input, wherein the set of instructions is generated using an AI model in accordance with the set of verbal commands.

15. The computer-implemented method of claim 13, further comprising:
detecting, by the set of sensors, spatial information related to a position or orientation of the animatronic object, wherein the particular sequence of movements is generated using the AI model in accordance with the spatial information.

16. An interactive toy comprising:
a body structure;
a set of physical emoters integrated within the body structure, wherein each physical emoter of the set of physical emoters is associated with a corresponding movement path defining a range of motion for one or more segments of the interactive toy;
one or more input sensors embedded in the body structure and configured to capture input content from an environment surrounding the interactive toy;
a computing device integrated within or communicatively coupled to the interactive toy, wherein the computing device is configured to:
construct a prompt configured to operate as an input into an AI model using the captured input content,
receive, from the AI model, (a) a response to the prompt and (b) metadata comprising instructions to categorize each portion of the response into a particular physical animation of a set of predefined animations based on a common visual attribute indicated by the portion of the response and the particular physical animation, and
map each physical animation to one or more physical emoters associated with respective segments of the toy in accordance with the physical animation, wherein each physical animation is configured to be executed using one or more physical emoters of the set of physical emoters for a particular time period corresponding to a respective portion of the response; and
an output controller configured to execute the set of physical animations for the particular time period by using the one or more physical emoters to trigger movement of respective segments of the interactive toy.

17. The interactive toy of claim 16, further comprising:
a Near Field Communication (NFC) reader configured to detect one or more NFC tags associated with auxiliary objects proximate to the interactive toy,
wherein the computing device is further configured to:
identify a set of characteristics of the auxiliary objects based on metadata indicated by the one or more NFC tags, and
modify the prompt to instruct the AI model to indicate the identified set of characteristics of the auxiliary objects within the response.

18. The interactive toy of claim 16, wherein the set of physical emoters includes:
a facial expression emoter configured to control movement of one or more facial features of the interactive toy,
a head rotation emoter configured to control rotation of a head of the interactive toy, and
a limb articulation emoter configured to control movement of one or more limbs of the interactive toy.

19. The interactive toy of claim 16,
provide a database comprising pre-defined emoter activation sequences;
identify one or more actions based on the metadata associated with the physical animation; and
determine the set of physical animations by selecting one or more pre-defined emoter activation sequences based on the identified actions.

20. The interactive toy of claim 16, wherein the one or more input sensors include a gyroscope and accelerometer coupled to the body structure.
